(19) United States
(12) Patent Application Publication
(10) Pub. No.: US 2025/0361113 A1
(43) Pub. Date: Nov. 27, 2025

(54) APPARATUS FOR PROCESSING SHEETS

(71) Applicant: DUPLO SEIKO CORPORATION, Kinokawa-shi (JP)

(72) Inventors: Yuya NAKADE, Kinokawa-shi (JP); Masahiko MORI, Kinokawa-shi (JP); Kenta TAKIMOTO, Kinokawa-shi (JP)

(73) Assignee: DUPLO SEIKO CORPORATION, Kinokawa-shi (JP)

(21) Appl. No.: 19/219,028

(22) Filed: May 27, 2025

(30) Foreign Application Priority Data
May 27, 2024 (JP) 2024-085904
May 1, 2025 (JP) 2025-076464

(51) Int. Cl. B65H 43/08; B65H 37/04; B65H 37/06

(52) U.S. Cl. CPC B65H 43/08; B65H 37/04; B65H 37/06; B65H 2301/45; B65H 2301/5113; B65H 2301/5161; B65H 2557/20

(57) ABSTRACT

An apparatus for processing sheets includes a conveyor that conveys a sheet on which a plurality of fold lines are set, a folder that folds the sheet conveyed by the conveyor along the fold lines, an applicator that applies an adhesive to the sheet and a controller configured to control the conveyor, the folder, and the applicator. The controller includes an acquirer configured to acquire processing information of the sheet, a fold line determinator configured to determine, based on the processing information acquired by the acquirer, which one of the plurality of fold lines along which the sheet is to be folded by the folder and a folding controller configured to control the folder to fold the sheet in accordance with determination of the fold line determinator.

### BACKGROUND

### Technical Field

The present disclosure relates to an apparatus for processing sheets.

### Background Art

Conventionally, there has been known an apparatus for processing sheets that processes a conveyed sheet. JP2023115754A discloses an apparatus for processing sheets having folders and adhesive applicators.

In the apparatus disclosed in JP2023115754A, a plurality of folders and adhesive applicators are disposed, and in this case, when processing sheets of various shapes and sizes, it is difficult for the user of the apparatus for processing sheets to determine which folder should be used to fold which fold line of the sheet and which adhesive applicator should be used to apply an adhesive to the sheet.

### SUMMARY

An object of the present disclosure is to provide an apparatus for processing sheets that can easily fold sheets using sheet processing information when processing sheets of various shapes and sizes.

An apparatus for processing sheets according to the present disclosure, includes:
a conveyor that conveys a sheet on which a plurality of fold lines are set;
a folder that folds the sheet conveyed by the conveyor along the fold lines;
an applicator that applies an adhesive to the sheet; and
a controller configured to control the conveyor, the folder, and the applicator, wherein
the controller includes:
   an acquirer configured to acquire processing information of the sheet;
   a fold line determinator configured to determine, based on the processing information acquired by the acquirer, which one of the plurality of fold lines along which the sheet is to be folded by the folder; and
   a folding controller configured to control the folder to fold the sheet in accordance with determination of the fold line determinator.

According to the apparatus for processing sheets of the present disclosure, the sheet can be folded at a proper position determined by the fold line determinator in accordance with the processing information.

### BRIEF DESCRIPTION OF DRAWINGS

FIG. 1 is a longitudinal cross-section view showing a schematic configuration of an apparatus for processing sheets according to an embodiment;

FIG. 2 is a plan view of the apparatus for processing sheets;

FIG. 3 is an enlarged perspective view of a first folder and a conveying roller in FIG. 1;

FIG. 4 is a plan view of FIG. 3;

FIG. 5 is an enlarged cross-section view taken along line A of FIG. 4;

FIG. 6 is a diagram showing how a folder of the apparatus for processing sheets is used;

FIG. 7 is an enlarged cross-section view taken along line D of FIG. 6;

FIG. 8 is an enlarged cross-section view taken along line B of FIG. 1;

FIG. 9 is a plan view of FIG. 8;

FIG. 10 is a cross-section view taken along line C of FIG. 8;

FIG. 11 is a perspective view of a nipping roller and a support for the nipping roller of the apparatus for processing sheets;

FIG. 12 is a plan view of FIG. 11;

FIG. 13 is a front view of the nipping roller and the support;

FIG. 14 is a longitudinal cross-section view of the nipping roller and the support;

FIG. 15 is a diagram showing a state where the nipping rollers of the apparatus for processing sheets are used;

FIG. 16 is a control block diagram of the apparatus for processing sheets;

FIG. 17 is a diagram showing a state where the folder is used;

FIGS. 18A-18D are diagrams showing states where the folder is used;

FIG. 19A-19C are diagrams showing states where the folder is used;

FIG. 20 is a control flow of the apparatus for processing sheets;

FIG. 21 is a diagram showing a state where the folder is used;

FIG. 22 is a control flow of the apparatus for processing sheets; and

FIG. 23 is a diagram showing a state where the folder is used.

### DETAILED DESCRIPTION

An apparatus for processing sheets according to the first aspect of the present disclosure includes:
a conveyor that conveys a sheet on which a plurality of fold lines are set;
a folder that folds the sheet conveyed by the conveyor along the fold lines;
an applicator that applies an adhesive to the sheet; and
a controller configured to control the conveyor, the folder, and the applicator, wherein
the controller includes:
   an acquirer configured to acquire processing information of the sheet;
   a fold line determinator configured to determine, based on the processing information acquired by the acquirer, which one of the plurality of fold lines along which the sheet is to be folded by the folder; and
   a folding controller configured to control the folder to fold the sheet in accordance with determination of the fold line determinator.

The apparatus for processing sheets according to the second aspect of the present disclosure, in the first aspect, includes:
a loading tray on which the sheets to be folded by the folder are stacked, wherein
the controller includes:
   a calculator configured to calculate, based on the processing information acquired by the acquirer, a loading position at which the sheets are to be loaded on the loading tray; and
   a loading instructor configured to instruct the user to load the sheets at the loading position calculated by the calculator.

The apparatus for processing sheets according to the third aspect of the present disclosure, in the second aspect, includes:
a guide that guides a side of the sheets loaded on the loading tray, wherein
the loading instructor includes a guide instructor indicating a position of the guide in a direction intersecting a conveyance direction of the conveyor.

The apparatus for processing sheets according to the fourth aspect of the present disclosure, in the second aspect, wherein
the applicator includes:
   a nozzle configured to apply an adhesive to the sheet; and
   a nozzle mover that moves the nozzle relative to the sheet,
wherein the calculator includes an application calculator configured to determine the loading position within a range in which the nozzle is movable relative to the sheet by the nozzle mover.

The apparatus for processing sheets according to the fifth aspect of the present disclosure, in the first or second aspect, wherein
the folder includes a plurality of holding members for holding hold pieces of the sheet on the conveyance path, and
the folding controller includes a hold determinator configured to determine which of the plurality of holding members to use.

The apparatus for processing sheets according to the sixth aspect of the present disclosure, in the first or second aspect, includes:
a sensor that detects the sheet on the conveyance path; and
a sensor mover that moves the sensor in a direction intersecting a conveyance direction of the conveyor, wherein
the controller controls, based on the processing information, the sensor mover to move the sensor to a predetermined position in the direction intersecting the conveyance direction.

The apparatus for processing sheets according to the seventh aspect of the present disclosure, in the sixth aspect, wherein the controller is configured to detect, via the sensor, whether the sheet is loaded at a predetermined loading position.

The apparatus for processing sheets according to the eighth aspect of the present disclosure, in the seventh aspect, wherein the controller outputs a warning signal when the sheet is not loaded at the predetermined loading position.

### Embodiment

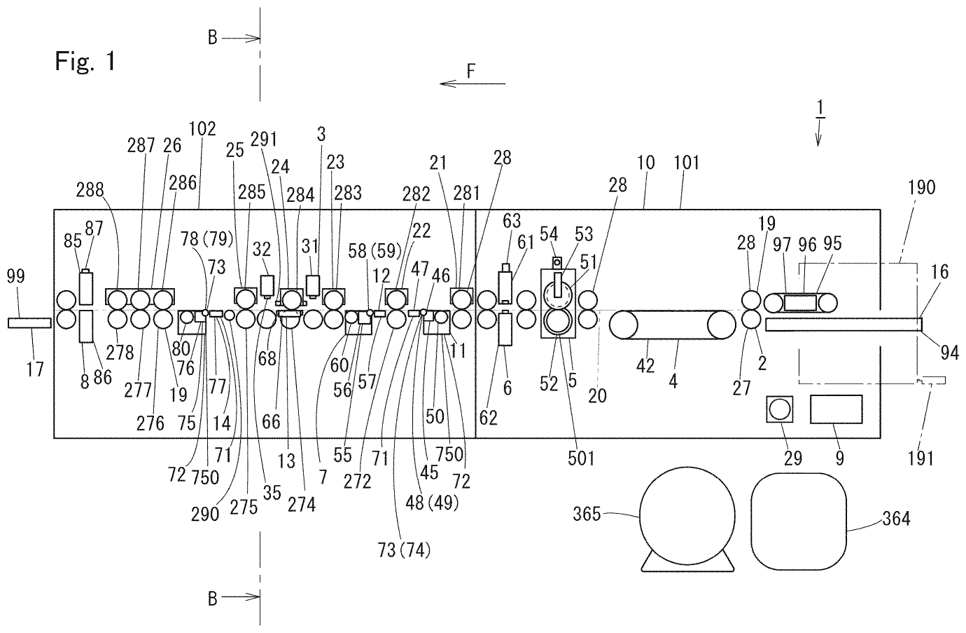

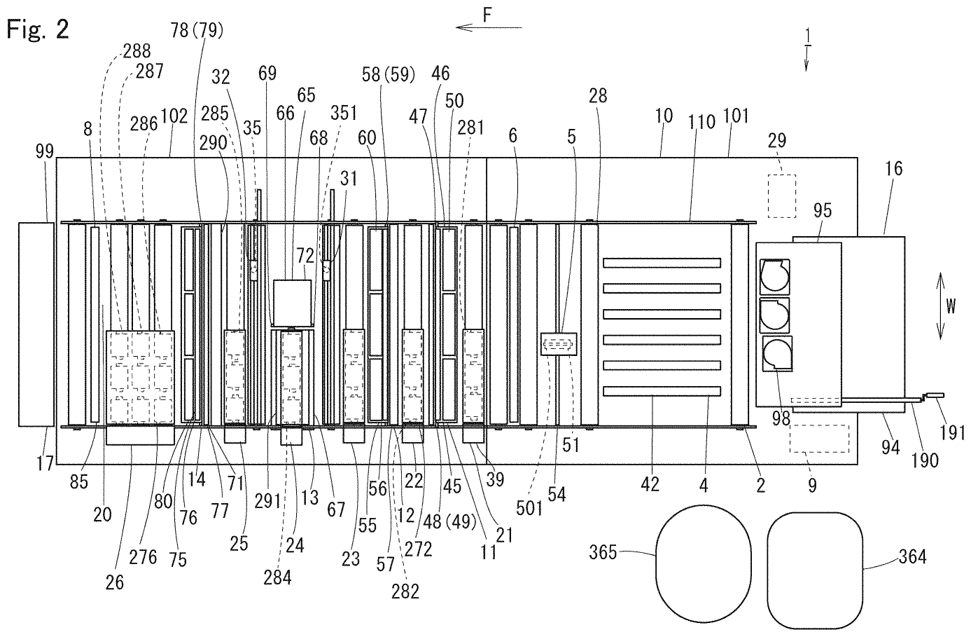

FIG. 1 is a longitudinal cross-section view showing a schematic configuration of an apparatus for processing sheets 1, and FIG. 2 is a plan view of the apparatus for processing sheets 1. The apparatus for processing sheets 1 includes a first machine 101 and a second machine 102. The first machine 101 includes a supplier 16, a conveyor 4, a first creaser 5, and a second creaser 6. The second machine 102 includes a folder 7, an applicator 3, a presser 8, and a discharger 17.

The apparatus for processing sheets 1 has a machine body 10 within which a controller 9 is disposed for controlling the action of the entire machine. A conveyance path 20 is formed from the supplier 16 to the discharger 17 by a conveyor 2 having a plurality of conveying rollers 27 for conveying sheets S. The conveyor 2 conveys the sheets S in a first direction. The first direction is a conveyance direction F when the sheets S are conveyed by the conveyor 2.

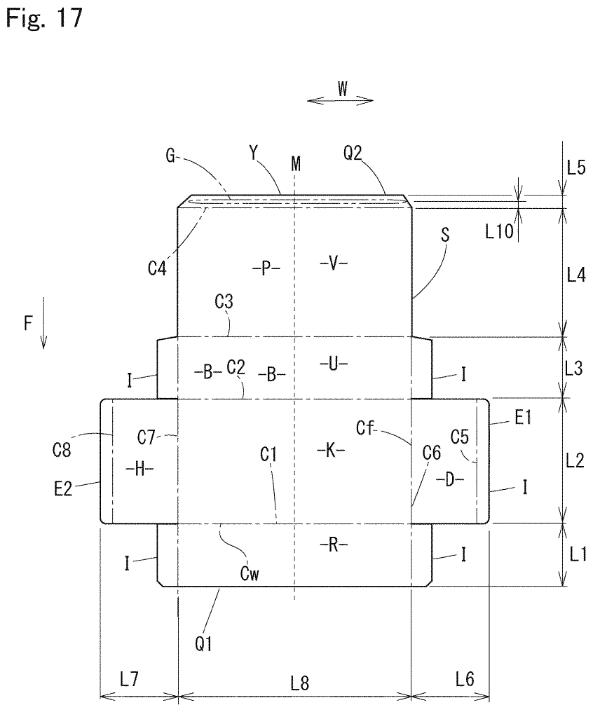

The supplier 16 includes a loading tray 94, a guide 190, and a suction conveyor 95. The loading tray 94 is loaded with sheets S to be folded in the folder 7. The loading tray 94 is lifted and lowered by a lifter not shown. The guide 190 guides sides of the sheets S loaded on the loading tray 94. The sheets S is abutted at their side edges E1 (see FIG. 17) against the guide 190. The user of the apparatus for processing sheets 1 can adjust the position on the conveyance path 20 of the sheets S in a width direction W, which is a cross direction intersecting the conveyance direction F, by abutting one side edges E1 of the sheets S against the guide 190. The position of the guide 190 in the cross direction intersecting the conveyance direction F can be adjusted by a position adjuster 191. The position adjuster 191 includes an operation part such as a handwheel. The user manually operates the operation part to move the guide 190 in the cross direction. FIG. 2 shows a case where the cross direction is the width direction W orthogonal to the conveyance direction F. The suction conveyor 95 includes a suction box 96 and a conveying belt 97. The suction box 96 is connected to a blower 98 shown in FIG. 2. Negative pressure is generated in the suction box 96 by driving the blower 98, so that the topmost sheet S on the loading tray 94 is sucked to the lower surface of the conveying belt 97.

The conveyor 4 includes a conveying belt 42. The sheet S is conveyed downstream along the conveyance direction F by the travel of the conveying belt 42.

The first creaser 5 forms a longitudinal fold line C (see FIG. 17) on the sheet S along the conveyance direction F as a first direction. The first creaser 5 includes a first crease blade 501, a separator 53, and a transverse mover 54. The first crease blade 501 includes an upper member 51 and a lower member 52. The upper member 51 is disposed above the conveyance path 20. The upper member 51 has a disk shape, with a concave groove formed on its circumferential surface. The concave groove is disposed along the conveyance direction F. The lower member 52 is disposed below the conveyance path 20 at a position facing the upper member 51. The lower member 52 has a disk shape with substantially the same radius as the upper member 51, the lower member 52 having on its circumferential surface a convex portion that engages with the concave groove. The blade tip of the convex portion is disposed along the conveyance direction F. The separator 53 separates the upper member 51 from the lower member 52. The transverse mover 54 moves the upper member 51 and the lower member 52 together in a width direction W orthogonal to the conveyance direction F.

The second creaser 6 forms the fold line C on the sheet S along a second direction. The second direction is a direction intersecting the conveyance direction F when the sheet S is conveyed by the conveyor 2. The second direction is the width direction W of the sheet S. The second creaser 6 includes a recessed member 61, a protruding member 62, and a vertical mover 63. The recessed member 61 is disposed above the conveyance path 20 and is raised and lowered by the vertical mover 63. The protruding member 62 faces the recessed member 61 and is disposed below the conveyance path 20. The recess of the recessed member 61 and the protrusion of the protruding member 62 are disposed along the width direction W.

The folder 7 folds the sheet S conveyed by the conveyor 2 along the fold line C. The folder 7 includes first to fourth folders 11 to 14. The first, second and fourth folders 11, 12 and 14 are transverse folders that fold the sheet S at a transverse crease CW along the width direction W orthogonal to the conveyance direction F of the conveyor 2. A third folder 13 is a longitudinal folder that folds the sheet S at a longitudinal crease along the conveyance direction of the conveyor 2.

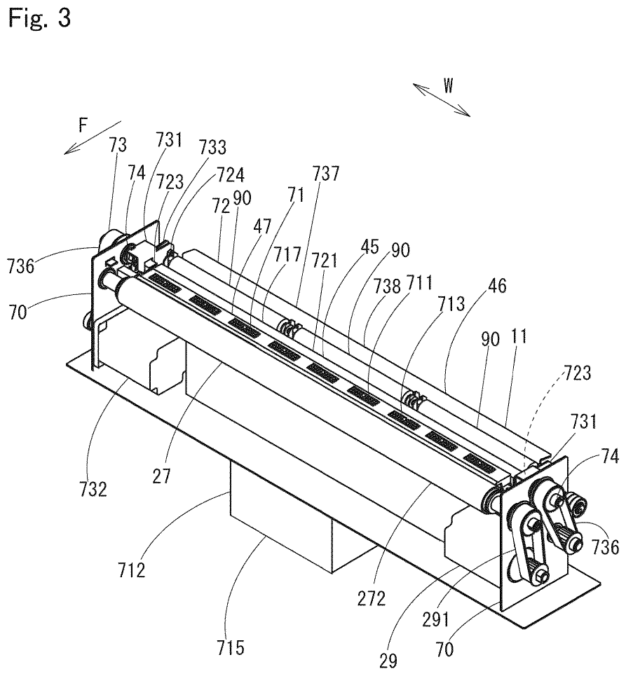

The folder 7 includes a holder 71 and a rotor 72. The holder 71 includes a plurality of holding members 711 (see FIG. 3) for holding a hold piece B of the sheet S on the conveyance path 20. The rotor 72 folds back a fold piece P of the sheet S to a position facing the sheet S held on the conveyance path 20 by the holding members 711. At this time, a nipping roller 28 facing a conveying roller 27 across the conveyance plane of the sheet S is retracted from the conveyance path 20 by a retractor 39.

After a rotation drive 73 rotates a rotary section 750, the sheet S is conveyed downstream by the conveying roller 27 and a foldback roller 90 facing the conveying roller 27. Alternatively, instead of this, the rotation drive 73 returns the rotary section 750 to its original position, and the nipping roller 28 is caused to face the conveying roller 27 so that the sheet S is clamped by a conveying roller 272 and the nipping roller 28 and conveyed downstream.

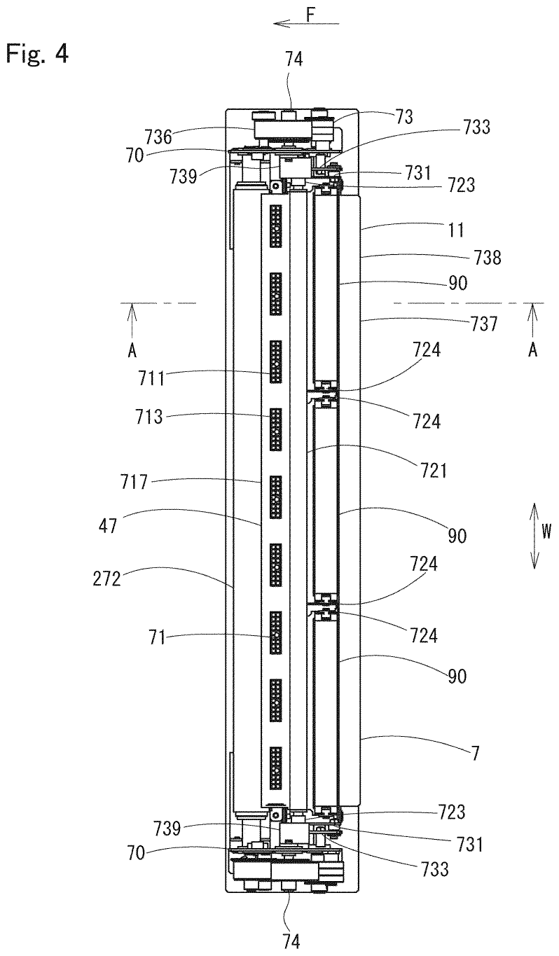

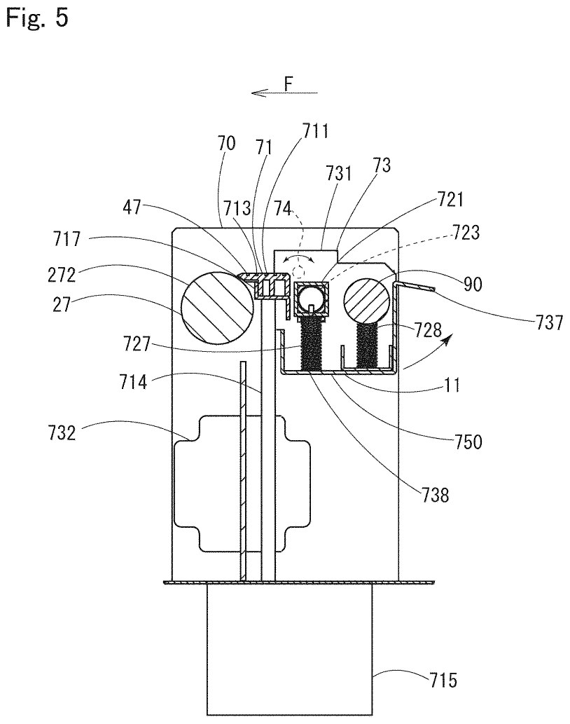

FIG. 3 is an enlarged perspective view of a first folder 11 and the conveying roller 272 on the downstream side of the first folder 11. FIG. 4 is a plan view of FIG. 3. FIG. 5 is a cross-section view taken along line A of FIG. 4.

The holder 71 includes the holding members 711 and a sucker 712. A plurality of ventilation holes 713 are formed in the holding members 711. The plurality of holding members 711 are arranged side by side in the width direction. The holding members 711 are supported by a support member 717. The support member 717 supports the plurality of holding members 711.

The sucker 712 sucks and holds the sheet S on the holding members 711. The sucker 712 includes a plurality of connection members 714, a switcher 715, and a negative pressure generator (not shown). The connection members 714 are formed of a flexible tube. The connection members 714 are disposed along the width direction W. The connection member 714 has one end connected to the ventilation hole 713 and the other end connected to the switcher 715. The switcher 715 switches the range in which the sheet S is sucked and held on the holding members 711 in response to the driving of the negative pressure generator.

The rotor 72 includes a foldback guide 721, the foldback roller 90, and the rotation drive 73. The foldback guide 721 and the foldback roller 90 extend in the width direction W. When not folding the sheet S, the foldback guide 721 and the foldback roller 90 lie at a support position below the conveyance path 20. At the support position, the foldback guide 721 and the foldback roller 90 support the sheet S conveyed on the conveyance path 20 from below. The foldback guide 721 and the foldback roller 90 of the first folder 11 shown in FIGS. 3 and 4 are located upstream of a first holder 47 of the first folder 11 at the support position.

In this embodiment, the foldback guide 721 is shown formed in a hollow rectangular cylindrical shape. However, the foldback guide 721 is not limited thereto, and may have a triangular or other polygonal cross section, may be formed in a prism shape, or may have other shapes such as a plate shape or a circular cylindrical shape. The foldback guide 721 is supported at its left and right ends by a support 731 via a bearing 723. The foldback guide 721 is biased by a biasing member 727.

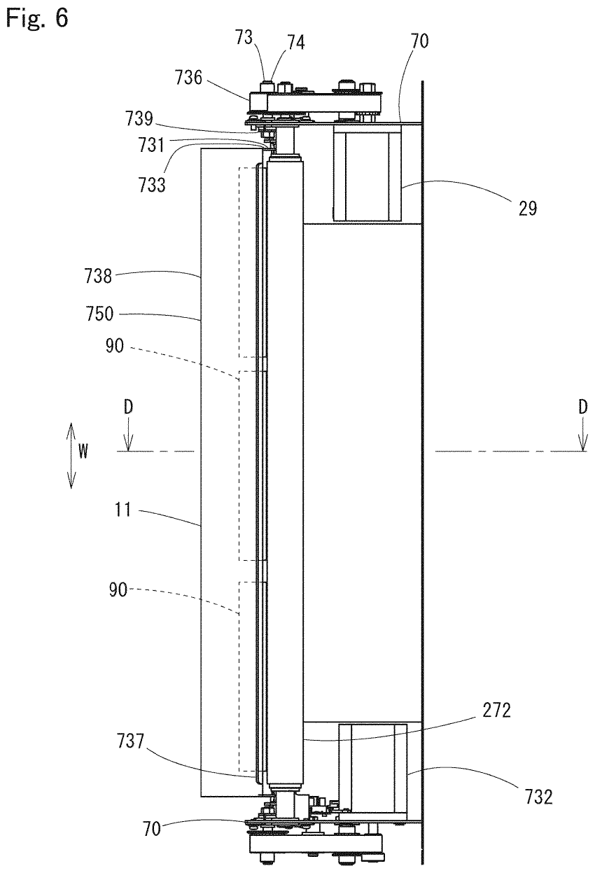

In this embodiment, the foldback roller 90 is shown divided into three in the width direction W. However, the foldback roller 90 need not be divided, and may be a single roller extending along the width direction W. Each foldback roller 90 is pivotably supported at its both ends in the width direction W by the support 731 via a bearing 724. In addition, each foldback roller 90 is biased by a biasing member 728. After folding the sheet S, the foldback roller 90 can clamp the folded sheet S between the foldback roller 90 and the conveying roller 27 and convey it. FIG. 6 is a view of the first folder 11 in a state where the rotor 72 of FIG. 4 is inverted, as viewed from the downstream side in the conveyance direction F.

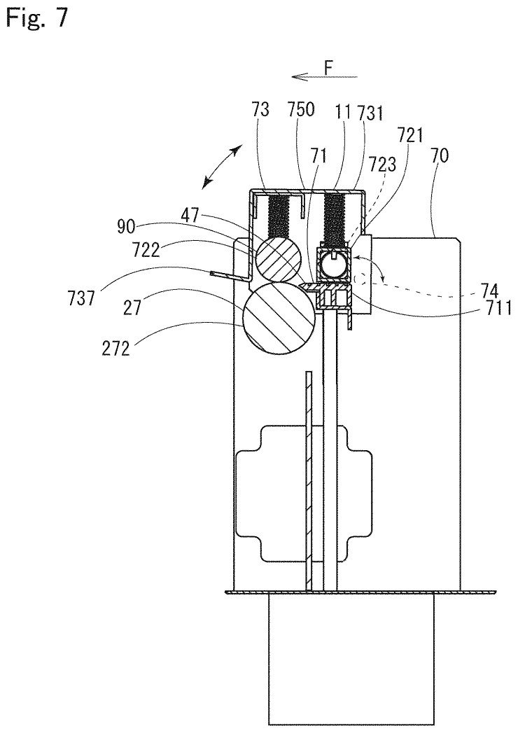

The rotation drive 73 inverts the foldback guide 721 and the foldback roller 90 from the support position shown in FIG. 5 to the fold position shown in FIG. 7 across the conveyance plane of the sheet S. The rotation drive 73 includes the support 731, a pivot 74, a power transmitter 736, a link assembly 733, and a folding drive 732. The support 731 includes a housing 738 and a connecting member 739.

The housing 738 is formed in a rectangular parallelepiped shape, which is elongated in the width direction W, with a top surface open at the support position. The foldback guide 721 and the plurality of foldback rollers 90 are housed and pivotably supported inside the housing 738. A conveyance guide 737 is disposed in the housing 738. The conveyance guide 737 guides the sheet S. The connecting member 739 connects the housing 738 to the pivot 74. The foldback rollers 90, the foldback guide 721, and the support 731 constitute the rotary section 750.

The pivot 74 is disposed outside the housing 738 in the width direction W and is pivotably supported by a side plate 70. The pivot 74 is connected to the folding drive 732 via the power transmitter 736.

The link assembly 733 is a mechanism for releasing the pressing force of the foldback guide 721 pressing the sheet S against the holding members 711 at the fold position shown in FIG. 7, to properly convey the folded sheet S. A pair of link assemblies 733 are disposed on the left and right. The link assemblies 733 are disposed between the side plate 70 and the left and right ends of the housing 738.

Of the first to fourth folders 11 to 14, the first folder 11 is disposed on the most upstream side. The first folder 11 includes the first holder 47 and a first folding-back part 46. The first folding-back part 46 includes a first rotating member 45, a first foldback roller 50, and a first rotator 48. The first rotator 48 has a first pivot 49 as its axis and inverts the rotary section 750 housing the first rotating member 45 and the first foldback roller 50 toward the downstream side across the conveyance plane of the sheet S. The first rotating member 45 faces the first holder 47 lying on the downstream side. The first foldback roller 50 faces the conveying roller 272 lying on the downstream side.

After the first rotator 48 rotates the rotary section 750, the sheet S is conveyed downstream by the conveying roller 272 and the first foldback roller 50 facing the conveying roller 272, or the first rotator 48 returns the rotary section 750 to its original position, causes a nipping roller 282 to face the conveying roller 272, and clamps the sheet S between the conveying roller 272 and the nipping roller 282 to convey it downstream.

A second folder 12 is disposed downstream of the first folder 11. The second folder 12 includes a second holder 57 and a second folding-back part 56. The second folding-back part 56 includes a second rotating member 55, a second foldback roller 60, and a second rotator 58. The second rotator 58 inverts, around a second pivot 59 as its axis, the rotary section 750 housing the second rotating member 55 and the second foldback roller 60 toward the upstream side across the conveyance plane of the sheet S toward the upstream second holder 57. The second rotating member 55 faces the upstream second holder 57. The second foldback roller 60 faces the upstream conveying roller 272.

At this time, the nipping roller 282 above the conveying roller 272 is retracted from the conveyance path 20 by a second retractor 22. In the first folder 11, the rotary section 750 including the first rotating member 45 is rotated about the pivot 74 from the upstream side to the downstream side in the conveyance direction F of the sheet S, whereas in the second folder 12, the rotary section 750 is rotated about the second pivot 59 from the downstream side to the upstream side in the conveyance direction F of the sheet S.

After the second rotator 58 has rotated the rotary section 750, the sheet S is conveyed downstream by the conveying roller 272 and the second foldback roller 60 in the fold position, or the second rotator 58 returns the rotary section 750 to its original state, to move the nipping roller 282 from the retraction position to the clamping position and clamp the sheet S by the conveying roller 272 and the nipping roller 282 for conveyance to the downstream side.

The third folder 13 is disposed downstream of the second folder 12 and between two applicators 3. The third folder 13 includes a third holder 67, a third folding-back part 66, and a mover not shown. The third folding-back part 66 includes a third rotator 68.

As shown in FIG. 2, the third holder 67 and the third folding-back part 66 are arranged side by side in the width direction W. The third rotator 68 has a third pivot 69 as its axis and rotates the third rotating member 65 toward the third holder 67 disposed adjacent thereto in the width direction W. At this time, a nipping roller 284 above a conveying roller 274 is retracted from the conveyance path 20. The mover moves the third folding-back part 66 and the third holder 67 together in the width direction W, aligning them with the position of the fold line C.

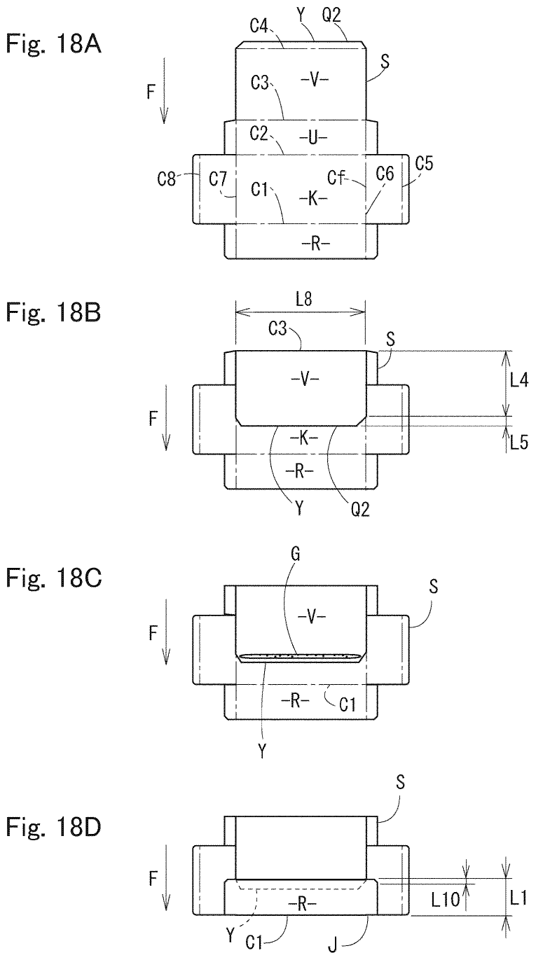

A pressing member 291 is disposed on a pivot support 37 of the nipping roller 284 above the conveying roller 274. The pressing member 291 presses a fourth piece V and a fifth piece Y as fold pieces P of the sheet S folded by the first folder 11 in a folding manner shown in FIG. 18, which will be described later, toward a second piece K and a third piece U as the hold pieces B when an adhesive G is applied by a second applicator 32.

A fourth folder 14 is disposed downstream of the second applicator 32. The fourth folder 14 includes a fourth folding-back part 76, a fourth holder 77, and a conveying roller 290. The fourth folding-back part 76 includes a fourth rotating member 75, a fourth foldback roller 80, and a fourth rotator 78. The fourth rotator 78 turns over, around a fourth pivot 79 as its axis, the rotary section 750 including the fourth rotating member 75 and the fourth foldback roller 80 toward the upstream fourth holder 77 across the conveyance plane of the sheet S. The fourth rotating member 75 faces the upstream fourth holder 77. The fourth foldback roller 80 faces the upstream conveying roller 290.

At this time, a nipping roller 285 above a conveying roller 275 is retracted from the conveyance path 20 by a fifth retractor 25.

In the fourth folder 14, similarly to the second folder 12, the rotary section 750 rotates about the fourth pivot 79 from the downstream side to the upstream side in the sheet S conveyance direction F. The fourth folder 14 is movable in the conveyance direction F. Since the fourth folder 14 is movable in the conveyance direction F in accordance with the size of the sheet S and the position of the fold line C, various sheets S having different lengths from the application position of the adhesive G to the fold line C can be folded in the fourth folder 14 and bonded with the adhesive G.

The applicator 3 shown in FIGS. 1 and 2 applies the adhesive G to the sheet S. The applicator 3 includes first and second applicators 31 and 32. The first applicator 31 is disposed between the second folder 12 and the third folder 13. The second applicator 32 is disposed between the third folder 13 and the fourth folder 14.

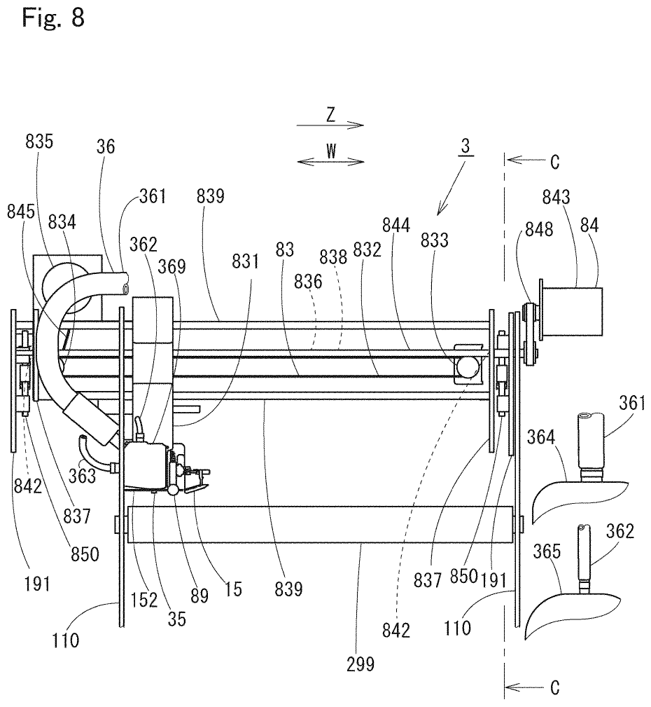

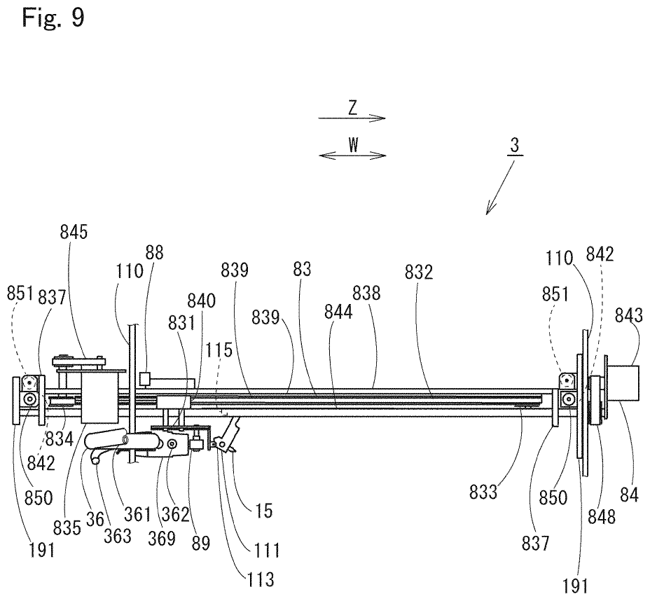

FIG. 8 is an enlarged cross-section view taken along line B in FIG. 1. FIG. 9 is a plan view of FIG. 8. The second applicator 32 includes a nozzle 35, an applicator 369, a supplier 36 for adhesive G, a nozzle mover 83, a lift 84, a pressing member 89, a guide 15, and a position sensor 88. The first applicator 31 has a similar configuration to the second applicator 32. The nozzle 35 is for applying the adhesive G to the sheet S. The nozzle 35 ejects adhesive G. The nozzle 35 applies the adhesive G to the sheet S in which the fold piece P is folded along the fold line C. The nozzle 35 can be an injection nozzle that injects the adhesive G toward the sheet S at a predetermined pressure. The nozzle 35 is disposed under the applicator 369. The applicator 369 is mounted on a carriage 831 of the nozzle mover 83. The applicator 369 is connected to a supplier 36 for the adhesive G and a communication wiring 363 to the controller 9.

The adhesive G supplier 36 supplies the adhesive G to the nozzle 35. The adhesive G supplier 36 includes tubes 361 and 362, an adhesive G tank 364, and a compressor 365. The tube 361 connects the applicator 369 to the adhesive G tank 364. If the adhesive G is of a type that melts when heated, the tube 361 includes a heater. The tube 362 connects the applicator 369 to the compressor 365.

The nozzle mover 83 moves the nozzle 35 relative to the sheet S. The nozzle mover 83 shown in FIG. 8 shows a case where the nozzle 35 is moved in the width direction W. The nozzle mover 83 includes a carriage 831, a carrier body 836, a belt 832, rollers 833 and 834 for movement, a rail 839, a slider 840, and a moving drive 835. The nozzle 35 is mounted on the carriage 831. The carrier body 836 includes a pair of left and right flat plates 837 and a bridge member 838 bridged on the flat plates 837. The left end of the flat plate 837 shown on the left side in FIG. 8 is disposed between the left side plate 110 and the auxiliary plate 191 in FIG. 8 that constitute the device body 10. The area between the side plate 110 and the auxiliary plate 191 shown on the left side in FIG. 8 is a cleaning area for cleaning the nozzle 35.

The belt 832 has an endless shape. The belt 832 is stretched over mover rollers 833 and 834. The pair of mover rollers 833 and 834 are disposed on the left and right sides at a predetermined distance in the width direction W. The mover rollers 833 and 834 are fixed to the bridge member 838. The carriage 831 is connected to a predetermined position of the belt 832 running below. One of the mover rollers 834 is connected to a moving drive 835 via a connecting member 845. Two rails 839 are disposed, one above the other. Each rail 839 extends in the width direction W at a predetermined height. The slider 840 is connected to the carriage 831 and slides on the rail 839. Both ends of the rail 839 in the width direction W are fixed to the flat plate 837.

When the mover rollers 833 and 834 are rotated by the drive of the moving drive 835, the belt 832 runs in a circle. The carriage 831 fixed at a predetermined position on the belt 832 is moved in the width direction W while being guided by a rail 839. FIG. 8 shows a case where the nozzle 35 is located at the home position. The home position of the nozzle 3 is set near the left side plate 110.

The application direction Z of the adhesive G is a direction in which the nozzle 35 is moved relative to the sheet S by the nozzle mover 83 to apply the adhesive G. In the case of the nozzle 35 shown in FIG. 8, when applying the adhesive G to the sheet S, the carriage 831 is moved from the home position to the right in FIG. 8. The adhesive G is discharged from the nozzle 35 when the carriage 831 moves to the right in FIG. 8. In FIG. 8, the movement direction of the nozzle 35 from left to right is the application direction Z in which the adhesive G is applied.

When the nozzle mover 83 moves the nozzle 35 to the cleaning region, the nozzle 35 moves to the left in FIG. 8. This movement of the nozzle 35 to the left from the home position in FIG. 8 is a movement in the opposite direction to the application direction Z. When the nozzle 35 is moved to the cleaning region, the nozzle 35 is moved upstream in the application direction Z.

The lift 84 moves the nozzle 35 between an application position and the retraction position. The application position is a position where the adhesive G is applied to the sheet S. The retraction position is a position where the nozzle 35 is retracted from the application position. The lift 84 brings the nozzle 35 close to the sheet S at the application position. At the application position, the adhesive G is applied. When lifting and lowering the nozzle 35 from the application position to the retraction position, the lift 84 moves the nozzle 35 away from the sheet S.

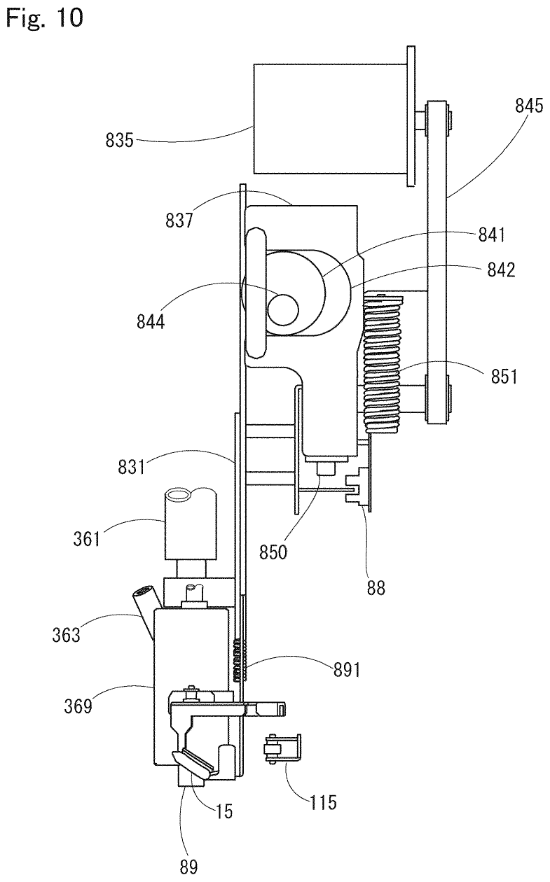

FIG. 10 is an enlarged cross-section view taken along the line C in FIG. 8. The lift 84 includes an eccentric cam 841, a cam follower 842, a cam shaft 844, a guide shaft 850, an elastic member 851, the lifting/lowering drive 843 shown in FIG. 3, and a height sensor 900. The eccentric cam 841 and the cam follower 842 are disposed in pairs on the left and right. The cam follower 842 is disposed on the flat plate 837. The cam shaft 844 is fixed to the eccentric position of the left and right eccentric cams 841. The cam shaft 844 is connected to the lifting/lowering drive 843 by a connecting member 848. The guide shaft 850 guides the lifting/lowering of the nozzle mover 83. The elastic member 851 assists the nozzle mover 83 in moving upward from the application position to the retraction position.

Driving of the lifting drive 843 rotates the cam shaft 844 via the connecting member 848, and rotates the pair of left and right eccentric cams 841. Rotation of the eccentric cam 841 causes the flat plate 837 disposed with the cam follower 842 to move up and down while being guided by the guide shaft 850. The lift 84 raises and lowers the flat plate 837, and moves the entire nozzle mover 83 in the up and down direction. This moves the nozzle 35 between the application position and the retraction position.

The pressing member 89 presses the sheet S from above. The pressing member 89 presses the sheet S toward a conveying roller 299 disposed below and facing the sheet S via the conveyance plane of the sheet S. The pressing member 89 is urged toward the conveying roller 299 by an urging member 891 with a predetermined pressure. FIG. 8 shows a case in which the pressing member 89 is configured as a pressing roller. The pressing member 89 is mounted on a carriage 831 in a position near the nozzle 35. The pressing member 89 is disposed between the nozzle 35 and the guide 15.

The presser 8 presses the fold line C of the sheet S. The presser 8 includes a pair of upper and lower pressing members 85, 86 and a press mover 87. The pair of pressing members 85, 86 are disposed facing each other above and below via the conveyance path 20. The press mover 87 raises and lowers the pressing member 85 disposed above the conveyance path 20 toward the other opposing pressing member 86.

The worked sheet S is placed on the discharger 17. The discharger 17 includes a discharge tray 99.

The conveyor 2 is configured to pinch the sheet S and convey it from the supplier 16 to the discharger 17. The conveyor 2 conveys the sheet S on which a plurality of fold lines C are set. The conveyor 2 includes the conveying roller 27, the nipping roller 28, the transport drive 29, and the retractor 39. The conveying roller 27 is disposed below the conveyance path 20. The conveying roller 27 is connected to the transport drive via a power transmitter (not shown).

The length in the width direction W of all the other conveying rollers 27 except for the conveying roller 274 disposed in the third folder 13 is set to be longer than the length in the width direction W of the conveyance path 20 along which the sheet S is conveyed. The length of the conveying roller 274 disposed in the third folder 13 is shorter than the length in the width direction W of the conveyance path 20, that is, about half the length.

The nipping rollers 28 are disposed above the conveyance path 20. The nipping rollers 28 pinch and convey the sheet S between themselves and the conveying rollers 27. The nipping rollers 28 rotate in accordance with the rotation of the opposing conveying rollers 27 driven by the conveying drive 29. All the nipping rollers 28 of the first machine 101 and the nipping rollers 28 arranged at the most downstream side of a second machine 102 are formed so that their lengths in the width direction W are longer than the length in the width direction W of the conveyance path 20 along which the sheet S is conveyed. These nipping rollers 28 have substantially the same length in the width direction W as the opposing conveying rollers 27.

In contrast, nipping rollers 281 to 288 disposed upstream of the presser 8 of the second machine 102 are disposed in a range shorter than the length of the width direction W of the conveyance path 20. In FIG. 2, the nipping rollers 281 to 288 upstream of the presser 8 of the second machine 102 are disposed with a length of about half the width direction W of the conveyance path 20.

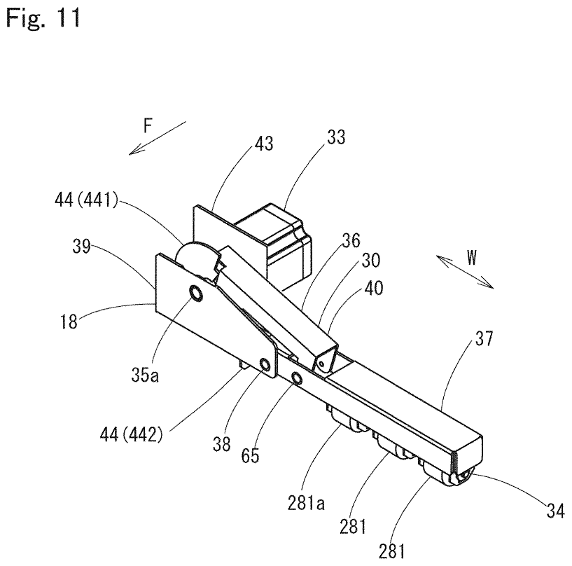

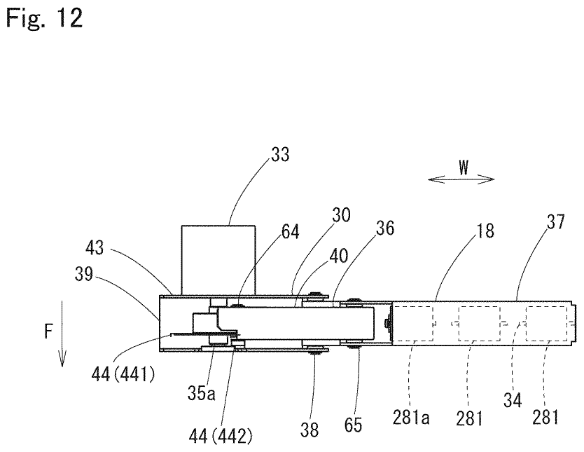

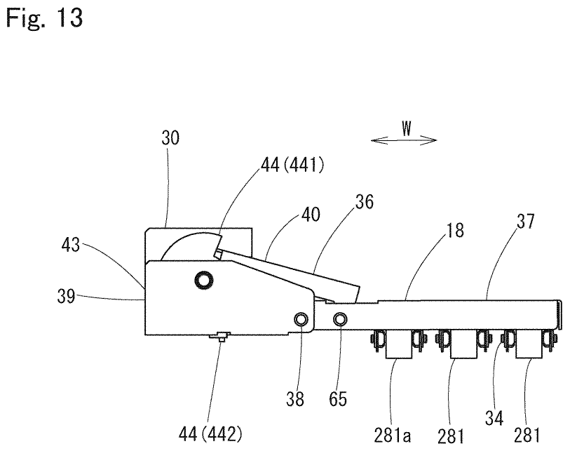

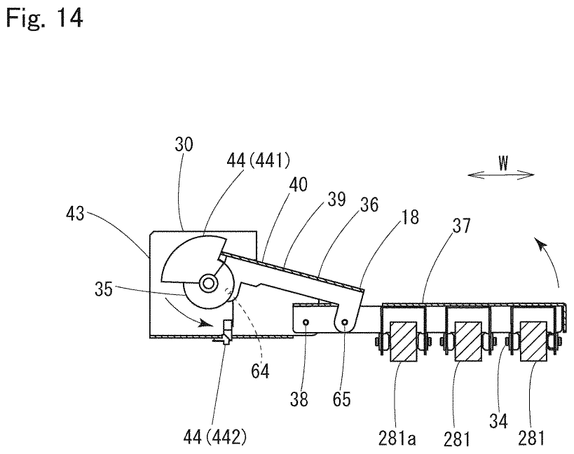

FIG. 11 is a perspective view of the nipping roller 281 on the most upstream side of the second machine 102 and the support 18 for the nipping roller 281. FIG. 12 is a plan view of the nipping roller 281 and the support 18. FIG. 13 is a view of the nipping roller 281 and the support 18 as viewed from the front. FIG. 14 is a longitudinal cross-section view of the nipping roller 281 and the support 18.

The nipping roller 281 located at the most upstream of the second machine 102 is divided into plural pieces in the width direction W. The support 18 includes the pivot support 37 and the retractor 39. The pivot support 37 pivotally supports each of the divided nipping rollers 281. The pivot support 37 is formed in a transversely elongated rectangular parallelepiped shape with an open bottom, and houses the nipping rollers 281 therein. These nipping rollers 281 are configured to be retractable from the conveyance path 20 by the retractor 39 while remaining supported by the pivot support 37.

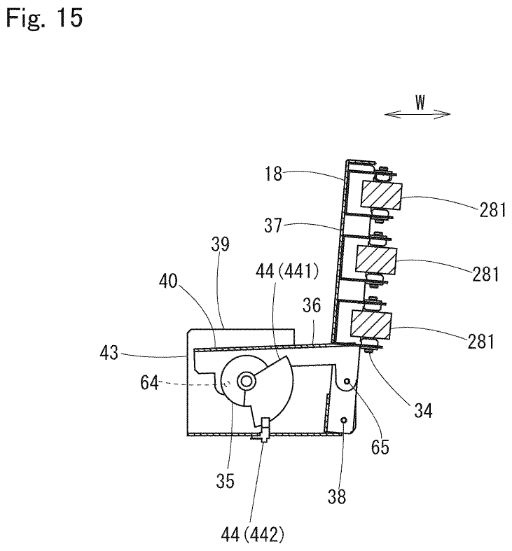

The retractor 39 retracts the nipping rollers 28 from the conveyance path 20 when the sheet S is folded in the folder 7. The retractor 39 moves the nipping rollers 28 from a clamping position in which the pivots 34 of the nipping rollers 281 are aligned along the width direction W orthogonal to the conveyance direction F of the conveyor 2 to the retraction position in which the pivots 34 intersect with the width direction W. In this embodiment, as shown in FIG. 15, a case is shown in which the pivots 34 are aligned along the up-down direction at the retraction position.

The retractor 39 includes a mover 30. The mover 30 moves the pivot support 37, which pivotally supports the nipping roller 281, toward the outside of the conveyance path 20. The mover 30 includes a swinger 40. The swinger 40 swings the pivot support 37 about the swing shaft 38. The swing shaft 38 extends along the conveyance direction F. The swinger 40 includes a retraction drive 33, a support base 43, a rotating body 35, a link 36, and a detector 44. The detector 44 includes a light shielding plate 441 and an optical sensor 442.

The retraction drive 33, the rotor 35, and the swing shaft 38 are supported by a support base 43 fixed to the device body 10. The rotor 35 is rotated by the drive of the retraction drive 33. One end of a link 36 is connected to the disk surface of the rotor 35 by a pin 64. The other end of the link 36 is connected by a pin 65 between the swing shaft 38 of the pivot support 37 and a nipping roller 281a located at the leftmost position in FIG. 13.

A light shielding plate 441 is fixed to the pivot 35a of the rotating body 35. The light shielding plate 441 is detected by a sensor 442 disposed below the rotating body 35, and detects whether the nipping roller 281 is located at the retraction position or the clamping position.

When the sheet S is conveyed, the nipping roller 281 is located at the clamping position. When the sheet S is folded, the nipping roller 281 moves to the retraction position. When moving to the retraction position, the retraction drive 33 is driven, and the rotating body 35 is rotated a predetermined amount counterclockwise in FIG. 11. The rotation of the rotating body 35 moves the link 36 to the left in the figure, and moves the connection part to the link 36 by the pin 65 of the pivot support 37 to the left in the figure. This causes the pivot support 37 to swing about the swing shaft 38 as its axis.

As shown in FIGS. 14 and 15, the pivot support 37 moves from a transverse position to a vertical position while supporting the nipping roller 281. The installation direction of the nipping roller 281 is changed by approximately 90 degrees. The movement of the nipping roller 281 from the pinch position to the retraction position opens the conveyance path 20.

The other nipping rollers 282 to 288 upstream of the presser 8 of the second machine 102 have substantially the same configuration as the nipping roller 281 and its support 18 disposed at the most upstream of the second machine 102 shown in FIGS. 11 to 15. The nipping rollers 286 to 288 facing three conveying rollers 276 to 278 disposed adjacent to the upstream side of the presser 8 are moved together by a single retractor 39 from the pinch position to the retraction position.

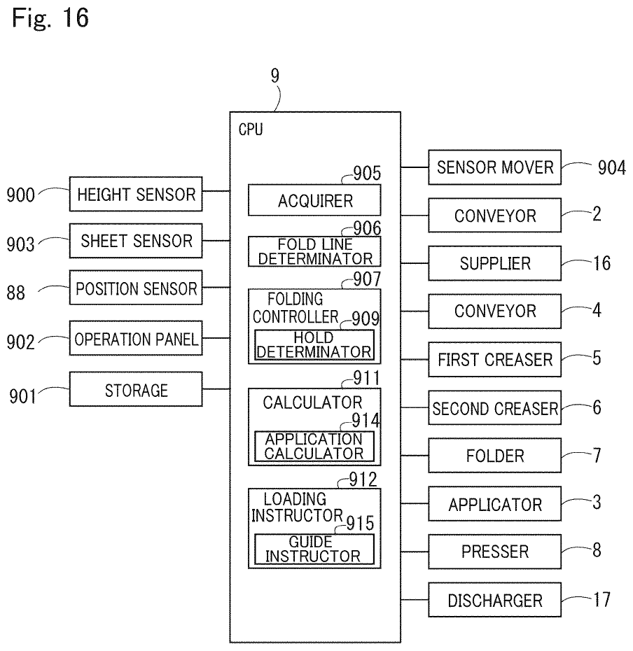

FIG. 16 is a block diagram of the control of the apparatus for processing sheets 1. The controller 9 controls various operations of the apparatus for processing sheets 1. The controller 9 is composed of a CPU. The controller 9 controls various operations of the conveyor 2, the supplier 16, the conveyor 4, the first creaser 5, the second creaser 6, the folder 7, the applicator 3, the presser 8, and the discharger 17. The controller 9 receives signals from various input devices. The controller 9 controls various output devices in response to signals received from the input devices. The controller 9 performs calculations for applying the adhesive G onto the sheet S and folding the sheet S.

A storage 901 is connected to the controller 9. The storage 901 may be a ROM, a RAM, or an EEPROM in which various programs are stored. Various information related to the sheet S is stored in the storage 901. The storage 901 stores, for example, the size, shape, type, thickness, paper quality, hardness, surface treatment state, punching die shape, form, type, number of sheets, crease position, adhesive G application position, etc. of the sheet S.

The controller 9 is connected to an operation panel 902. The operation panel 902 is configured to serve as an input operation part such as buttons and switches, a display device such as a display, and an output part such as a notifier that notifies the occurrence of an error by sound or light. The operation panel 902 constitutes an input for the user to input various processing information including processing positions such as the shape, number, fold line position, application position of adhesive G, and fold position regarding the sheets S. The various processing information is input automatically or manually by the user operating the input operation part. In addition, it is also possible for the user to input or select a number or the like from the operation panel 902 to call up the form such as the size and shape of the sheets S from the storage 901 together with the processing information of the sheets S.

Various drives are connected to the controller 9. The drives can be constituted by motors. The motors can be, for example, stepping motors or DC motors. A stepping motor rotates the motor shaft in predetermined step units by applying a pulse signal, and the angle and speed of rotation can be accurately controlled, so that the transport amount of the sheet S, the movement amount of the nozzle 35, and the position of the sheet S on the conveyance path 20 can be controlled quickly and with high precision.

Various sensors are connected to the controller 9. The sensors include a sheet sensor 903 that detects the sheet S on the conveyance path 20. The sheet sensor 903 detects the leading or trailing end of the sheet S. The sensors also include a position sensor 88 for detecting the position of the nozzle 35.

The sheet sensor 903 can be moved in a cross direction crossing the conveyance direction F by a sensor mover 904. The controller 9 controls the sensor mover 904 to move the sheet sensor 903 to a predetermined position in the cross direction based on processing information. The controller 9 can use the sensor mover 904 to determine whether the sheet S is loaded in a proper loading position. The controller 9 can output a warning signal when it is determined that the sheet S is not loaded in a proper loading position.

The controller 9 includes an acquirer 905, a fold line determinator 906, and a folding controller 907. The acquirer 905 acquires processing information for the sheet S. The fold line determinator 906 determines, based on the processing information acquired by the acquirer 905, which one of the plural fold lines C along which the sheet S should be folded by the folder 7. The folding controller 907 controls the folder 7 to fold the sheet S in accordance with the determination by the fold line determinator 906. The folding controller 907 can include a hold determinator 909 that determines which of the plural holding members 711 to use.

The controller 9 may further include a calculator 911 and a loading instructor 912. The calculator 911 calculates a loading position at which the sheets S should be loaded on the loading tray 94, based on the processing information acquired by the acquirer 905. The loading instructor 912 prompts the sheets S to be loaded at the loading position calculated by the calculator 911.

The calculator 911 may include an application calculator 914 that determines a loading position at a position corresponding to a range in which the nozzle 35 can be moved relatively to the sheet S by the nozzle mover 83. The loading instructor 912 may include a guide instructor 915 that indicates the position of the guide 190 in a cross direction that crosses the conveyance direction F of the conveyor 2.

The operation of the apparatus for processing sheets 1 will then be described. When the apparatus for processing sheets 1 processes the sheet S, the controller 9 acquires processing information of the sheet S by the acquirer 905. Based on the processing information acquired by the acquirer 905, the fold line determinator 906 determines which one of the plural fold lines C along which the sheet S should be folded by the folder 7. The folding controller 907 controls the folder 7 to fold the sheet S according to the determination by the fold line determinator 906.

Thus, the controller 9 acquires processing information such as the size and shape of the sheet S input from the input by the acquirer 905. The controller 9 determines which one of the plural fold lines C set on the sheet S along which the sheet S should be folded by the folder 7, based on the processing information of the sheet S acquired by the acquirer 905. Then, the controller 9 determines which folder 7 of the first to fourth folders 11 to 14 should be used to fold the sheet S along which fold line C. When the controller 9 determines to fold the sheet S in the fourth folder 14, the controller 9 moves the position of the fourth folder 14 in the conveyance direction F to a required position depending on the size of the sheet S and the position of the fold line C.

The controller 9 also determines whether to use the first applicator 31 or the second applicator 32 to apply the adhesive G. In accordance with these determinations, the controller 9 controls to work the sheet S. The controller 9 may determine to fold the sheet S by the fourth folder 14 and adhere the sheet S while keeping the sheet S positioned at the position where the adhesive G was applied by the second applicator 32.

Processing information such as the size, shape, and other aspects of the sheet S, the thickness of the sheet S, the position of the fold line C, and the application position of the adhesive G is input and set by the user of the apparatus for processing sheets 1 through the operation panel 902 or a communication terminal. Alternatively, the form of the sheet S may be detected by a detector (not shown) for detecting the form of the sheet S and transmitted to the controller 9.

FIG. 17 is a plan view showing an example of a sheet S worked by the apparatus for processing sheets 1. The sheet S is cut out in advance into a predetermined shape using a die. The sheet S has a hold piece B and a fold piece P. The hold piece B is held in the conveyance path 20 when the sheet S is folded. The fold piece P is folded to a position opposite the hold piece B. For example, when folding along a fold line C3, the hold piece B becomes a first piece R, the second piece K, and the third piece U, and the fold piece P becomes the fourth piece V and the fifth piece Y.

The sheet S has already formed therein longitudinal creases Cf along the conveyance direction F of the conveyor 2 or transverse creases Cw along the width direction W orthogonal to the conveyance direction F. Since the sheet S has already formed therein the longitudinal creases Cf and the transverse creases Cw, the first creaser 5 and the second creaser 6 are not used when processing the sheet S.

The sheet S has first to fourth creases C1 to C4 formed along the width direction W, and fifth to eighth creases C5 to C8 formed along the conveyance direction F at different positions in the width direction W. The sheet S is divided into five parts along the conveyance direction F by the first crease C1 to the fourth crease C4.

The central portion of the width direction W of the sheet S is divided into the first piece R, the second piece K, the third piece U, the fourth piece V, and the fifth piece Y from the downstream side in the conveyance direction F. The fifth piece Y is a glue tab. After the fifth piece Y is folded, adhesive is applied to its upper surface. The lengths of each segment in the conveyance direction F are as follows: the first piece R is a first length L1, the second piece K is a second length L2, the third piece U is a third length L3, the fourth piece V is a fourth length L4, and the fifth piece Y is a fifth length L5.

The sheet S shown in FIG. 17 is folded along the fold lines by processing with the apparatus for processing sheets 1 and is bonded with adhesive G to form a cylindrical workpiece J. This cylindrical workpiece J can be assembled into a rectangular box shape. When the workpiece J is assembled into a rectangular box shape, the length in the conveyance direction F is the same for the first and third pieces from the downstream side. Also, the length in the conveyance direction F is the same for the second and fourth pieces from the downstream side. That is, the length in the conveyance direction F of the third piece U is the first length L1 that is the same as that of the first piece R, and the length in the conveyance direction F of the fourth piece Vis the second length L2 that is the same as that of the second piece K. Furthermore, when the lengths in the conveyance direction F of all the first piece R to the fourth piece V are the same, the workpiece J can be obtained that can be assembled into a box with a vertically elongated rectangular shape and a square lid and bottom that can accommodate a wine bottle. On the other hand, the fifth piece Y is a glue margin, so it has a different length from the first piece R to the fourth piece V.

The second piece K in the center of the width direction W is the region from a sixth crease C6 to a seventh crease C7. A sixth piece D is disposed on the right side of the second piece K in FIG. 17. The sixth piece D is the region from a right side edge E1 of the sheet S to the sixth crease C6. The sixth piece D includes a flap I from the right side edge E1 of the sheet S to the sixth crease C5.

A seventh piece H is disposed on the left side of the second piece K in FIG. 17. The seventh piece H is the area from the seventh crease C7 to the left side edge E2 of the sheet S. The seventh piece H includes a flap I from the eighth crease C8 to the left side edge E2 of the sheet S.

The length in the width direction W of the sixth piece D is a sixth length L6. The length in the width direction W of the second piece K is an eighth length L8. The length in the width direction W of the seventh piece His a seventh length L7. The sheet S further includes flaps I on the left and right sides of the first piece R and the third piece U.

To work the sheet S having the shape shown in FIG. 17 into a cylindrical shape, for example, the following two methods are available. The first is a first method shown in FIGS. 18A-18D. In the first method, first, in the first folder 11, the fourth piece V and the fifth piece Y are folded back toward the downstream third piece U at the third crease C3. As a result, as shown in FIG. 18B, the fourth piece Vis superimposed on the second piece K and the third piece U. In addition, the fifth piece Y is superimposed on the second piece K.

Then, as shown in FIG. 18C, adhesive G is applied to the upper surface of the fifth piece Y in the first applicator 31 or the second applicator 32. After that, the first piece R is folded along the first crease C1 at the fourth folder 14 toward the second piece K and the fifth piece Y on the upstream side. As a result, the first piece R is superimposed on the second piece K and the fifth piece Y. Adhesive G is applied to the top of the fifth piece Y. The fifth piece Y and the first piece R are bonded together by the adhesive G, and the sheet S is worked into a cylindrical shape as shown in FIG. 18D, becoming the workpiece J.

In this first method, the second applicator 32 can process the sheet S more properly than the first applicator 31. Since the second applicator 32 is located downstream of the first applicator 31, after the adhesive G is applied to the fifth piece Y by the second applicator 32, the sheet S can be folded at the fourth folder 14 and bonded with the adhesive G without conveying the sheet S downstream, while the sheet S is positioned at the position where the adhesive G was applied. In this case, since it is not necessary to convey the sheet S after the adhesive G is applied, it is not necessary to return the nipping roller 28 to the conveying position and convey the sheet S. Hence, there is no problem that the adhesive G applied to the upper surface of the fifth piece Y adheres to the nipping roller 285 or the adhesive G stains the inside of the device.

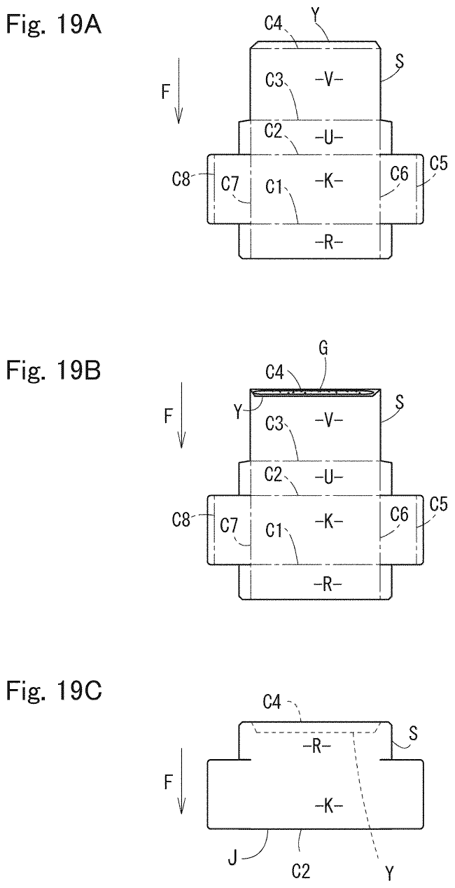

A second method for processing the sheet S shown in FIG. 17 is shown in FIGS. 19A-19C. In FIG. 19A, first, in the first folder 11, the fifth piece Y is folded toward the fourth piece V on the downstream side at the fourth crease C4. As a result, the fifth piece Y is superimposed on the fourth piece V as shown in FIG. 19B.

In the first applicator 31 or the second applicator 32, adhesive G is applied to the upper surface of the fifth piece Y. Then, in the fourth folder 14, the first piece R is placed on top of the fourth piece V and the fifth piece Y, and the second piece K is placed toward the third piece U, along the second crease C2, and folded. In this way, the first piece R is placed on top of the fifth piece Y. Adhesive G is applied to the top of the fifth piece Y. The fifth piece Y and the first piece R are bonded together by the adhesive G, and the sheet S is worked into a cylindrical shape to become the workpiece J as shown in FIG. 19C.

In the second method, similarly to the first method, the sheet S can be worked more properly by using the second applicator 32 rather than the first applicator 31.

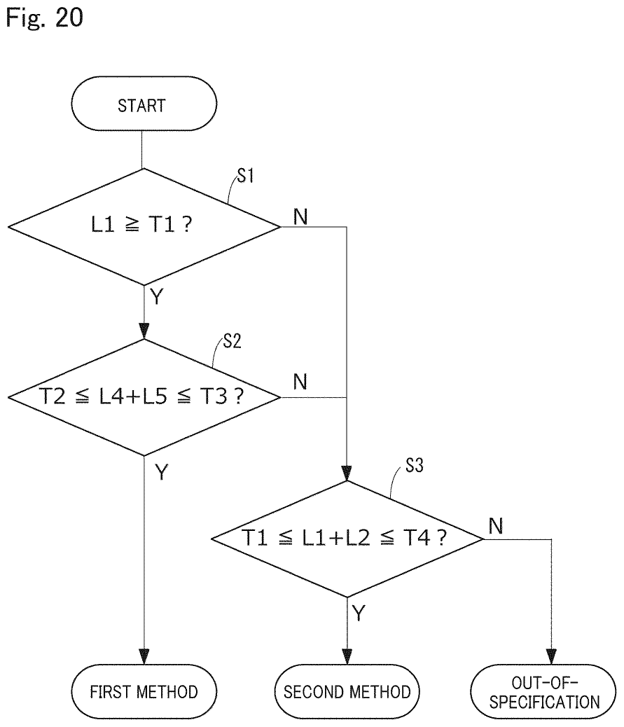

Whether the sheet S is worked by the first method or the second method may be determined, for example, depending on the size of the sheet S. FIG. 20 shows a flow for determining the method for processing the sheet S according to the size of the sheet S. At step S1 of FIG. 20, the controller 9 determines whether the first length L1 is equal to or greater than a first threshold value T1. The first threshold value T1 is the minimum length required for the fold piece P folded back from the downstream side to overlap the fifth piece Y to which the adhesive G has been applied by the second applicator 32.

In the first method, as shown in FIG. 18C, the first piece R is folded along the first crease C1 so as to overlap the second piece K on the upstream side in the conveyance direction F. At this time, the fifth piece Y, to which the adhesive G has been applied by the second applicator 32, is positioned at the application position of adhesive G, and the first piece R is folded from the downstream side to the upstream side at the fourth folder 14 to overlap the fifth piece Y.

In the second method, as shown in FIG. 19B, the sheet S is folded back so that the first piece R overlaps the fourth piece V to the fifth piece Y, and the second piece K overlaps the third piece U and the fourth piece V. At this time, the fifth piece Y, to which adhesive G has been applied by the second applicator 32, is kept positioned at the application position of adhesive G. The first threshold T1 is the minimum length required to fold and adhere the sheet S in this manner.

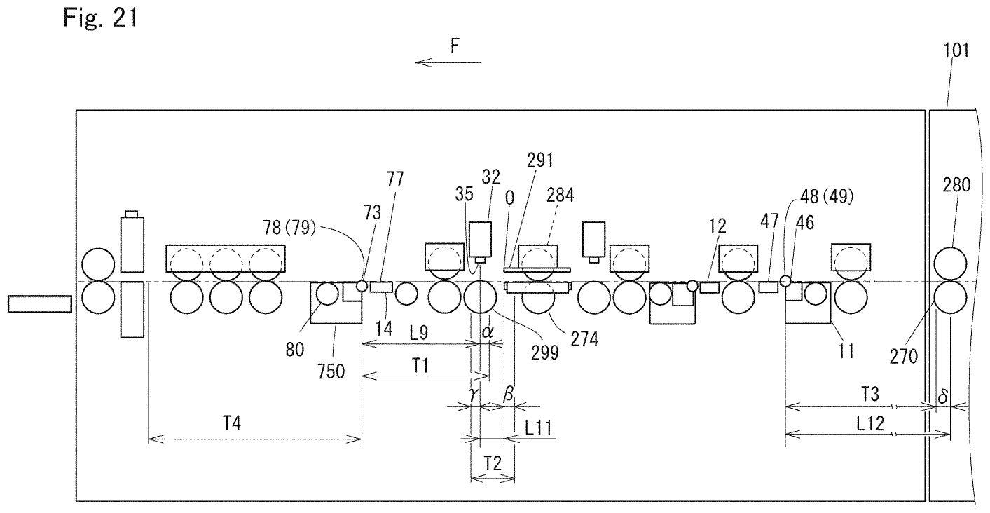

Thus, for example, as shown in FIG. 21, the first threshold T1 may be set to a value obtained by adding a predetermined value α to the minimum value of the length L9 in the conveyance direction F from the installation position of the second nozzle 35 to the installation position of the fourth pivot 79. Since the fourth folder 14 is movable in the conveyance direction F, the fourth folder 14 shown in FIG. 21 is located at the most upstream position within the range in which it can move in the conveyance direction F.

The predetermined value α is a length required for properly adhering the stacked sheets S after the adhesive G has been applied from the nozzle 35. More specifically, it is a length required for properly adhering the fold piece P folded back at the fourth folder 14 onto the sheet S to which the adhesive G has been applied from the second nozzle 35 shown in FIG. 1 disposed in the second applicator 32. The predetermined value α can be, for example, a length L10 from the center position in the conveyance direction F of the adhesive G application range of the fifth piece Y to the fourth crease C4 for defining the glue margin, as shown in FIGS. 17 and 18D.

In the case where the first length L1 is equal to or greater than the first threshold value T1, in the fourth folder 14, when the first piece R is folded back along the first crease C1, the first piece R can be properly overlapped on the fifth piece Y on the conveying roller 299 facing the second nozzle 35. As shown in FIG. 18C, the first piece R can be folded as shown in FIG. 18D without conveying the sheet S downstream while keeping the fifth piece Y in the position where the adhesive G was applied by the first method. This allows the sheet S to be properly folded by the first method.

If the first length L1 is equal to or greater than the first threshold T1, step S1 in FIG. 20 is satisfied, and the process proceeds to step S2. If the first length L1 is shorter than the first threshold T1, step S1 is not satisfied and the process proceeds to step S3.

At step S2, it is determined whether the sum of the fourth length L4 and the fifth length L5 is equal to or greater than the second threshold T2 and equal to or less than the third threshold T3. The sum of the fourth length L4 and the fifth length L5 is equal to the length from the edge Q2 of the fifth piece Y to the third crease C3 when the fourth piece V is folded downstream along the third crease C3 and placed on top of the third piece U in the first folder 11, as shown in FIG. 18B. When the adhesive G is applied by the second applicator 32 onto the fifth piece Y that has been folded at the first folder 11 and placed on top of the second piece K, the stiffness of the sheet S makes it easy for the fourth piece V and the fifth piece Y to lift up and tilt upward from the state where they are placed on the opposing second piece K and third piece U.

In this case, it becomes difficult to properly apply adhesive G onto the fifth piece Y. Hence, when applying adhesive G by the second applicator 32, the fourth piece V and the fifth piece Y folded at the first folder 11 are pressed by a pressing member 291.

The second threshold T2 is the minimum value of the length that allows the pressing member 291 to press the fourth and fifth pieces V and Y and to properly apply the adhesive G to the fifth piece Y when applying the adhesive G to the fifth piece Y. For example, as shown in FIG. 21, the second threshold T2 can be a value obtained by adding predetermined values β and γ to the length L11 in the conveyance direction F from the downstream end O of the pressing member 291 in the conveyance direction F to the installation position of the second nozzle 35, respectively, on the upstream side and the downstream side. The predetermined value β can be the minimum length that allows the pressing member 291 to press the folded sheet S. The predetermined value γ can be the minimum length required to apply the adhesive G from the second nozzle 35 to the fifth piece Y. If the sum of the fourth length L4 and the fifth length L5 is equal to or greater than the second threshold T2, the pressing member 291 can properly apply the adhesive G to the fifth piece Y while pressing the sheet S.

The third threshold T3 is the maximum length by which the sheet S can be folded in the first folder 11. When the sum of the length L4 of the fourth piece V and the length L5 of the fifth piece Y is equal to or less than the third threshold T3, the fourth piece V and the fifth piece Y can be folded toward the downstream side along the third crease C3 in the first folder 11. The third threshold T3 can be approximately a value obtained by subtracting a predetermined value δ from the length L12 in the conveyance direction F from the installation position of a most downstream nipping roller 280 (28) and a conveying roller 270 (27) of the first machine 101 to the installation position of the first pivot 49. The predetermined value δ is set to a value necessary for the sheet S not to be pinched by the most downstream nipping roller 280 and the conveying roller 270 of the first machine 101, and for the upstream edge Q2 of the sheet S not to come into contact with the most downstream nipping roller 280 of the first machine 101 during folding, and not to interfere with the folding process.

When the sum of the length L4 of the fourth piece V and the length L5 of the fifth piece Y is in the range between a second threshold value T2 and a third threshold value T3, the sheet S can be worked by the first method shown in FIGS. 18A-18D. Hence, the fold line determinator 906 of the controller 9 determines to work the sheet S by the first method.

At step S2, when the sum of the length L4 of the fourth piece V and the length L5 of the fifth piece Y is smaller than the second threshold value T2, the fourth piece V and the fifth piece Y cannot be properly pressed by the pressing member 291 in the second applicator 32. Also, when the sum of the length L4 of the fourth piece V and the length L5 of the fifth piece Y is greater than the third threshold value T3, the first folder 11 cannot be folded along the third crease C3. In such a case, proceed to step S3.

At step S3, it is determined whether the sum of the length L1 of the first piece R and the length L2 of the second piece K is equal to or greater than the first threshold value T1 and equal to or less than a fourth threshold value T4. The first threshold value T1 at step S3 is the same as the first threshold value T1 at step S1. The fourth threshold value T4 is the maximum length of the fold piece P that can be folded at the fourth folder 14. When the fourth folder 14 is located at the most upstream position in the conveyance direction F, the fourth threshold value T4 is the length of the fold piece P that can be folded from the downstream side to the upstream side in the conveyance direction F by rotating the fourth rotator 78 toward the upstream fourth holder 77.

When the first piece R and the length L2 of the second piece K is equal to or greater than the first threshold value T1 and equal to or less than the fourth threshold value T4, the sheet S can be worked by the second method shown in FIGS. 19A-19C. When step S3 is satisfied, the fold line determinator 906 of the controller 9 determines to work the sheet S by the second method.

At step S3 of FIG. 20, when the sum of the length L1 of the first piece R and the length L2 of the second piece K is smaller than the first threshold value T1 or greater than the fourth threshold value T4, the sheet S cannot be worked by either the first method shown in FIGS. 18A-18D or the second method shown in FIGS. 19A-19C and is outside the specifications.

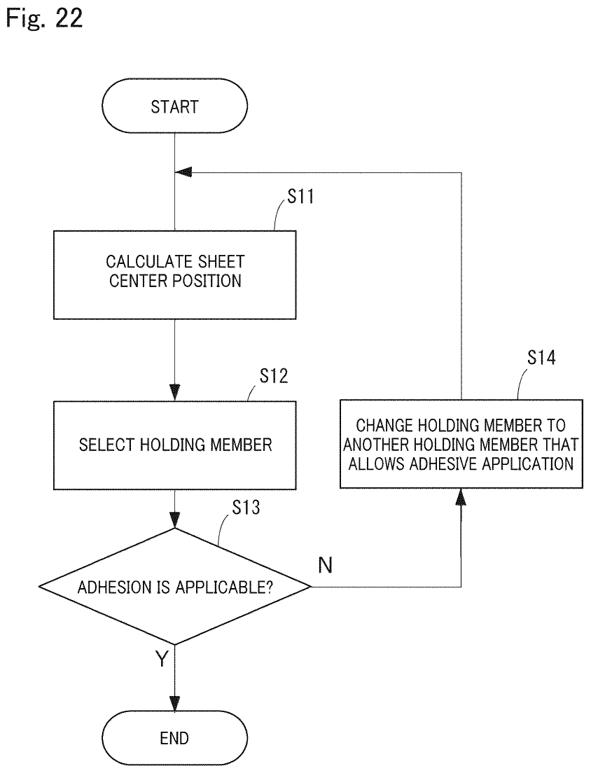

Furthermore, when the sheet S is worked by the apparatus for processing sheets 1, the hold determinator 909 determines which of the plural holding members 711 to use. FIG. 22 shows a flow for determining which holding member 711 to use to hold the sheet S in the folder 7 based on the processing information of the sheet S.

At step S11 of FIG. 22, the center position M of the sheet S in the width direction W is calculated. There are various methods for calculating the center position M of the sheet S. As an example, the controller 9 acquires the sixth length L6 and the eighth length L8 of the sheet S shown in FIG. 17. Then, half the value of the eighth length L8 is added to the sixth length L6 to calculate L6+L8/2. The sixth length L6 is the length of the sixth piece D disposed to the left of the second piece K in the center. When the sheet S is worked into the cylindrical workpiece J by the apparatus for processing sheets 1, the cylindrical workpiece J obtained by processing is assembled into a rectangular box. The sixth piece D becomes the bottom part or the lid part assembled into a box shape and the flaps adjacent to them.

When the workpiece J is assembled into a box shape, the seventh piece H becomes the lid or bottom part facing the sixth piece D. In the sheet S of FIG. 17, the length L6 in the width direction W of the sixth piece D and the length L7 in the width direction W of the seventh piece H are the same. Hence, in the sheet S shown in FIG. 17, the center position M in the width direction W of the sheet S can be calculated by adding half the length L8 in the width direction W of the second piece K to the length L6 in the width direction W of the sixth piece D to calculate L6+L8/2.

The sheet S worked by the apparatus for processing sheets 1 can be of various shapes, but when the apparatus for processing sheets 1 is used to obtain a cylindrical workpiece J from which a rectangular box can be assembled, the approximate center position M of the sheet S can be calculated by adding up half the length L8 of the width direction W of the second piece K, which is the length of the height of the rectangular box, and the length L6 of the width direction W of the sixth piece D, which is the lid or bottom part.

In the sheet S shown in FIG. 17, the length L6 in the width direction W of the sixth piece D and the length L7 in the width direction W of the seventh piece H are the same, but even if they are different, it is acceptable to assume that they are the same and calculate the approximate center position M of the sheet S.

The process proceeds to step S12 of FIG. 22 where the holding members 711 to be used to hold the sheet S when folding the sheet S are selected from among the plural holding members 711 arranged side by side in the width direction W in the folder 7. To this end, first, the arrangement of the holding members 711 is compared with the range in which the sheet S should be held when folding the sheet S along the fold line C, and the number of holding members 711 to be used to hold the sheet S is determined.

For example, as shown in FIG. 18B, when folding the sheet S along the third crease C3 by the first method, the fourth piece V and the fifth piece Y are folded back toward the third piece U while holding the third piece U. At this time, the third piece U needs to be sucked by the holding member 711. In this case, it is necessary to use the holding member 711 in the range of at least the eighth length L8.

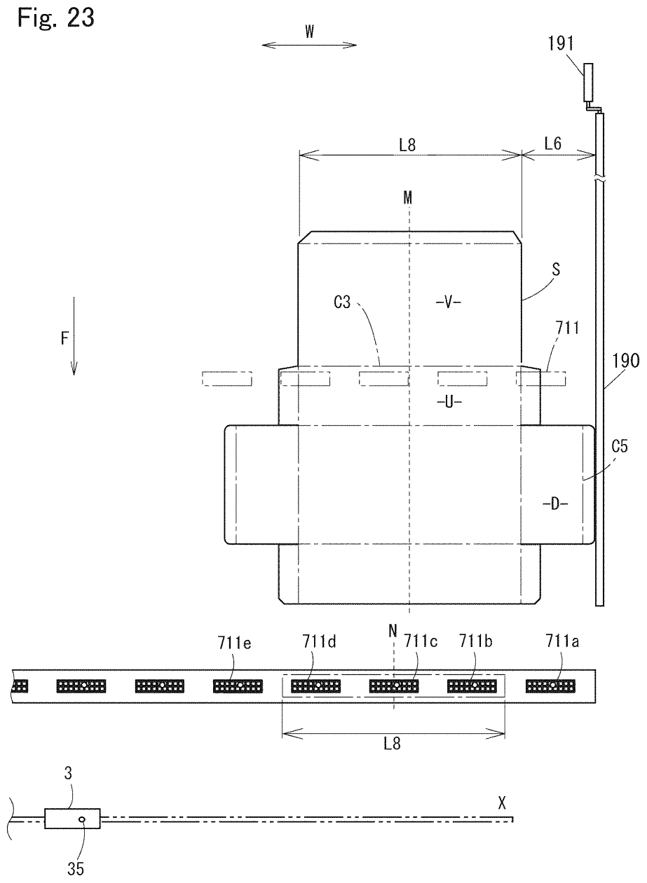

As shown in FIG. 23, if three holding members 711 are included in the range of the eighth length L8, the number of holding members 711 to be used to hold the sheet S will be three. Of the holding members 711 shown in the figure, a rightmost holding member 711a and a fifth holding member 711e from the right in the figure are not disposed in the range corresponding to the third piece U, and are therefore improper. On the other hand, second, third, and fourth holding members 711b, 711c, and 711d from the right in the figure are in the range corresponding to the third piece U.

A central position N is then determined from among the holding members 711b, 711c, and 711d to be used to hold the sheet S. Then, the central position M of the sheet S is aligned with the central position N of the holding members 711b, 711c, and 711d. In FIG. 23, the central position M of the sheet S is positioned at the central position N in the width direction W of the central holding member 711c among the three holding members 711b, 711c, and 711d to be used to hold the sheet S.

Depending on the size and shape of the sheet S, the number of holding members 711 to be used to hold the sheet S may be an even number, such as two or four. In such a case, the position where the even number of holding members 711 are separated symmetrically on the left and right is set to the center position N of the holding members 711, and the center position M of the sheet S is aligned with the position.

The controller 9 selects the holding member 711 that is to hold the sheet S based on the calculated central position N of the three holding members 711b, 711c, and 711d and the central position M of the sheet S.

Proceeding to step S13, when adhesive G is applied by the applicator 3 while the sheet S is held by the holding members 711b, 711c, and 711d selected at step S12, it is determined whether the position on the sheet S to which adhesive G should be applied is within the range X where adhesive G can be applied in the applicator 3. Since other mechanisms are disposed near the applicator 3, such as the installation of the retractor 39, the range where adhesive G can be applied by the nozzle 35 may be limited. Even if the folder 7 can fold the sheet S, there is a risk that the applicator 3 will not be able to apply adhesive G to the places where adhesive G needs to be applied.

Hence, at step S13, it is determined whether the nozzle 35 can move in the width direction W and whether adhesive G can be applied from the nozzle 35 to a position on the sheet S where adhesive G is to be applied. If it is within the range where the adhesive G can be applied at step S13, it is determined that the sheet S is to be held by the selected holding member 711, and the process ends.

If it is determined at step S13 that adhesive G cannot be applied, the process proceeds to step S14. At step S14, the holding member 711 is changed to another holding member 711 that allows application of the adhesive G. The process returns from step S14 to step S11, and a holding member 711 is selected in the same manner. The calculator 911 calculates a loading position where the sheets S should be loaded on the loading tray 94 in order to hold and fold the sheets S with the holding member 711 selected according to the flow of FIG. 22. The loading instructor 912 instructs the sheets S to be loaded at the loading position calculated by the calculator 911. That is, the loading instructor 912 displays on the operation panel 902 to specify the position of the guide 190. The user adjusts the position of the guide 190 by the position adjuster 191 according to the display on the operation panel 902.

The user loads the sheets S on the loading tray 94 by abutting the right side edge E1 against the guide 190 whose position in the width direction W has been adjusted. When the user performs an operation to start processing, the controller 9 drives the lifting assembly. The uppermost sheet S of the plural sheets S on the loading tray 94 is supplied to the downstream conveyor 4 by the suction conveyor 95. In the conveyor 4, the sheet S is conveyed downstream in the conveyance direction F by the travel of the conveying belt 42.

The sheet S passes through the first creaser 5 and the second creaser 6. When the sheet S is worked by the first method shown in FIGS. 18A-18D, the controller 9 stops the transport of the sheet S when the third crease C3 of the sheet S reaches the first folder 11. On the other hand, when the sheet S is worked by the second method shown in FIG. 19, the controller 9 stops the transport of the sheet S when the fourth crease C4 of the sheet S reaches the first folder 11.

The nipping rollers 281 and 282 are moved from the state in which they clamp the sheet S to a retraction position on the side of the conveyance path 20. The sheet S is released from the state in which it was sandwiched between the nipping rollers 281 and 282 on the conveyance path 20. The upper surface of the sheet S around the first fold 11 is exposed.

Meanwhile, the lower surface of the sheet S is supported by the conveying rollers 27 and the first holder 47 on the lower side of the conveyance path 20. When the nipping rollers 281 move to the retraction position, the controller 9 controls the switcher 715 of the first folder 11 so as to generate negative pressure in the holding member 711 selected according to the size and shape of the sheet S in accordance with the flow shown in FIG. 22. Then, the controller 9 drives the negative pressure generator. By driving the negative pressure generator, negative pressure is generated in the connection member 714 at a position corresponding to the portion of the sheet S held by the holding member 711, and the sheet S is sucked in through the ventilation hole 713. The sheet S is held on the holding member 711.

The controller 9 then drives the folding drive 732. By driving the folding drive 732, the pivot 74 is rotated a predetermined amount via the power transmitter 736. The rotary section 750 is rotated about the pivot 74. The first rotating member 45 and the first foldback roller 50 move to the fold position and face the first holder 47 and the conveying roller 272, respectively.

In the first method, the fourth piece V and the fifth piece Y are swung on the conveyance path 20 with the third crease C3 as the swing center, and are folded back in an arc toward the downstream side of the conveyance direction F to a position facing the second fold piece K and the third fold piece U. The fourth piece V and the fifth piece Y are overlapped on the second fold piece K and the third fold piece U.

In the second method, only the fifth piece Y is swung on the conveyance path 20 with the fourth crease C4 as the swing center and is folded back in an arc toward the downstream side of the conveyance direction F. The fifth piece Y is moved to a position facing the fourth fold piece V. The fifth piece Y is overlapped on the fourth piece V.

The sheet S is conveyed downstream with the downstream edge Q1 of the first piece R at the front. After the front end of the sheet S passes through the first applicator 31 and the third folder 13, when the fifth piece Y reaches the second applicator 32, the controller 9 stops the conveyor 2.

At this time, when the sheet S is worked by the first method, the fourth piece V is pressed by the pressing member 291 toward the second piece K and the third piece U that are stacked underneath.

The controller 9 drives the moving drive 835. The nozzle 35 moves downstream in the application direction Z of the adhesive G. The controller 9 stops the moving drive 835 at a position where the nozzle 35 is at the most upstream position in the application direction Z of the fifth piece Y. The controller 9 drives the lift drive 843. The carriage 831 moves from the retraction position to the application position.

The fifth piece Y is guided by the thin plate 152 toward the hold piece B of the sheet S. Then, the fifth piece Y is pressed by the pressing member 89. The controller 9 sprays the adhesive G from the nozzle 35. The adhesive G is applied to the upper surface of the folded-back fifth piece Y.

When the carriage 831 reaches the downstream end of the fifth piece Y in the application direction Z, the controller 9 stops application of the adhesive G from the nozzle 35. The controller 9 also stops the moving drive 835. Then, the controller 9 drives the elevation drive 843 to move the carriage 831 from the application position to the retraction position. Thereafter, the controller 9 drives the moving drive 835 to move the carriage 831 to the left in FIG. 8, which is the opposite direction to when the adhesive G was applied. The controller 9 stops the carriage 831 at the application start position for the subsequent sheet S.

The controller 9 folds back the downstream portion of the sheet S toward the hold piece B without conveying the sheet S downstream while keeping the adhesive G applied to the fifth piece Y. At this time, the controller 9 first drives the fifth retractor 25 to move the upper nipping roller 285 of the conveyance path 20 disposed downstream of the second applicator 32 from the clamping position to the evacuation position. Depending on the size of the sheet S, the controller 9 moves the three nipping rollers 286 to 288 adjacent to the downstream side of the fourth folder 14 from the clamping position to the evacuation position together by a sixth retractor 26. As a result, when folding the downstream portion of the sheet S toward the fifth piece Y, the nipping rollers 285 to 288 are positioned on the fold piece P of the sheet S, and thus the folding operation is not hindered.

The controller 9 drives the fourth rotator 78. The fourth rotator 78 is swung about the fourth pivot 79, and reaches a position facing the fourth holder 77.

In the first method, the sheet S is folded at the first crease C1. In the second method, the sheet S is folded at the second crease C2. Then, the sheet S is placed on the hold piece B that is held on the conveyance path 20 by the holding member 711 at a corresponding position. The first piece R is adhered near the edge Q1 by the adhesive G on the fifth piece Y.

The controller 9 drives the conveying drive 29. The sheet S is conveyed downstream by the fourth foldback roller 80 and the conveying roller 290 facing it. After folding at the fourth folder 14, it is preferable to immediately convey the sheet S downstream by the fourth foldback roller 80 and the conveying roller 290 facing it. As a result, the fifth piece Y to which the adhesive G is applied and the first piece R superimposed on the fifth piece Y can be pressed from above and below by the fourth foldback roller 80 and the conveying roller 290 facing it within a short time after the adhesive G is applied. The adhesive G can be stretched evenly between the first piece R and the fifth piece Y by pressing, and the first piece R and the fifth piece Y are firmly bonded to each other. This prevents the adhesive G from clumping and solidifying, which deteriorates the quality of the workpiece J.

Instead of or in addition to the pressing operation of the adhesive G application portion by the fourth foldback roller 80 and the opposing conveying roller 290, the first piece R and the fifth piece Y may be pressed from above by the pressing member 89 at a previous stage. In this case, the controller 9 drives the lifting drive 843 to move the carriage 831 from the retraction position to the application position. The controller 9 may drive the moving drive 835 to reciprocate the carriage 831 downstream and upstream in the application direction Z, thereby pressing the first piece R and the fifth piece Y with the pressing member 89 and spreading the adhesive G evenly.

The controller 9 may rotate the fourth foldback roller 80 and the conveying roller 290 facing thereto in the reverse direction while the fourth folder 14 is moving downstream along the conveyance direction F. After the sheet S is folded at the fourth folder 14, the fourth folder 14 may be moved downstream along the conveyance direction F until the sheet S is delivered to the presser 8. In this case, by rotating the fourth foldback roller 80 and the conveying roller 290 facing thereto in the reverse direction while the fourth folder 14 is moving, the sheet S can be passed through the nip between the fourth foldback roller 80 and the conveying roller 290 plural times. The adhesive G-applied portion of the sheet S can be pressed plural times.

When the leading and trailing end portions of the sheet S reach the presser 8, the controller 9 stops the conveyor 2. The controller 9 lowers the upper pressing member 85 of the conveyance path 20 toward the lower pressing member 86. The sheet S is pressed by the pair of pressing members 85, 86 and firmly folded. The workpiece J obtained by the processing is discharged onto a discharge tray 99.

The apparatus for processing sheets 1 includes the conveyor 2 that conveys a sheet S on which a plurality of fold lines C are set, the folder 7 folding the sheet S conveyed by the conveyor 2 along the fold lines C, an applicator 3 that applies adhesive G to the sheet S, and a controller 9 that controls the operations of the conveyor 2, the folder 7, and the applicator 3. The controller 9 includes an acquirer 905 that acquires processing information for the sheet S, a fold line determinator 906 that determines which one of the plurality of fold lines C along which the sheet S should be folded by the folder 7 based on the processing information acquired by the acquirer 905, and the folding controller 907 that controls the folder 7 to fold the sheet S in accordance with the determination of the fold line determinator 906. Hence, the sheet S can be folded at a proper position determined by the fold line determinator in accordance with the processing information.

The folder 7 includes a plurality of holding members 711 for holding the hold piece B of the sheet S in the conveyance path 20, and when the folding controller 907 includes a hold determinator 909 that determines which holding member 711 to use among the plurality of holding members 711, the sheet S can be held in the conveyance path 20 using the holding member 711 required when folding the sheet S.

Furthermore, in the case where the loading tray 94 is included on which the sheets S to be folded in the folder 7 are loaded, and where the controller 9 includes the calculator 911 that calculates the loading position at which the sheets S should be loaded on the loading tray 94 based on the processing information acquired by the acquirer 905, and the loading instructor 912 that prompts the user to load the sheets S at the loading position calculated by the calculator 911, the controller 9 can allow the user to load the sheets S in a proper loading position where the sheets S can be properly folded based on the processing information.

Furthermore, in the case where the supplier 16 includes the guide 190 that guides the side of the sheets S loaded on the loading tray 94, and the loading instructor 912 includes a guide instructor 915 that indicates the position of the guide 190 in the cross direction that intersects with the conveyance direction F of the conveyor 2, the sheets S can be easily loaded at a proper position using the guide 190.

Furthermore, in the case where the applicator 3 includes the nozzle 35 for applying adhesive G onto the sheet S and the nozzle mover 83 for moving the nozzle 35 relative to the sheet S, and where the calculator 911 includes the application calculator 914 for determining the loading position at a position corresponding to the range in which the nozzle 35 can move relative to the sheet S by the nozzle mover 83, the sheet S can be loaded at a proper position on the loading tray 94 even if there is a range in which the nozzle 35 cannot apply adhesive G to the sheet S.

Furthermore, the sheet sensor 903 detecting the sheet S on the conveyance path 20 and the sensor mover 904 moving the sheet sensor 903 in the cross direction intersecting the conveyance direction F of the conveyor 2 are disposed, and the controller 9 controls the sensor mover 904 to move the sheet sensor 903 to a predetermined position in the cross direction based on the processing information, so that the sheet sensor 903 can be moved to a proper position according to the processing information of the sheet S to detect the sheet S. This eliminates the need to install plural sheet sensors in a direction crossing the conveyance direction F even when processing sheets S of various sizes and shapes, thereby reducing costs.

The controller 9 uses the sheet sensor 903 to determine whether the sheet S is loaded in a proper loading position, and can notify the user when the sheet S is placed at an improper position on the loading tray 94.

Furthermore, when the controller 9 determines that the sheets S are not loaded in a proper loading position, it outputs a warning signal and allows the user to load the sheets S in a proper position on the loading tray.

The present disclosure is not limited to the above embodiments. In each of the above embodiments, the first creaser 5 and the second creaser 6 are disposed, but a creasing assembly may not be disposed. In each of the first folder 11 to the fourth folder 14, the conveyance of the sheet S is stopped and the sheet S is folded, but instead, the fold piece may be folded without stopping the conveyance of the sheet. For example, the sheet may be folded by contacting the fold piece of the conveyed sheet and changing the orientation of the fold piece. In addition, the apparatus for processing sheets may be disposed inside the image processing device.

Although a position adjuster 191 for adjusting the position of the guide 190 in the width direction W is disposed, a position adjuster may not be disposed. In this case, the user may adjust the position of the sheet S on the loading tray according to a scale or the like displayed on the supplier. The position adjuster 191 includes a handle, but may include a movement assembly for automatically moving the guide in the width direction.

Although the nozzle mover 83 has been described as moving the nozzle 35 in the width direction W, the mover may also move the sheet relative to the nozzle. For example, the sheet conveyor is configured to also function as the mover, and the nozzle is fixed to the device body. In this case, the sheet moves relative to the nozzle. When the sheet is moved relative to the nozzle by the conveyor as the mover, adhesive is applied from the nozzle. Furthermore, when the sheet conveyor is configured to also function as a mover, the nozzle may be fixed to a carrier body that is movable between a switching position and the retraction position instead of the device body. And, instead of configuring the sheet conveyor to also function as the mover, another movement assembly moving the sheet relative to the nozzle may be disposed.

Furthermore, the nozzle mover 83 shown in FIG. 3 ejects adhesive G from the nozzle 35 and applies adhesive G to the sheet S when the carriage 831 is moved to the right, but adhesive may also be ejected from the nozzle and applied to the sheet when the carriage 831 is moved to the left. In this case, the nozzle guide is disposed downstream of the nozzle in the direction of movement of the carriage to the left. Also, adhesive may be applied when the carriage moves to the right and left in the width direction. When adhesive is applied when the carriage moves to the left and right in the width direction, it is desirable to install the nozzle guide at the right and left ends of the carriage.

The first and second applicators 31 and 32 apply the adhesive G to the sheet S along the width direction W, but the adhesive may be applied along a direction other than the width direction intersecting the sheet conveyance direction. The adhesive may also be applied along the sheet conveyance direction. Furthermore, the fold line of the sheet may be disposed along the conveyance direction, the fold piece may be swung in the width direction orthogonal to the conveyance direction, and the adhesive may be applied along the sheet conveyance direction. In this case, the fold piece is swung around the fold line along the conveyance direction of the sheet by the conveyor as the swing center. The fold piece and the main body are adjacent to each other in the width direction. The fold piece located on the other side in the width direction is swung toward the main body of the sheet S located on one side in the width direction. The movement direction of the nozzle mover is opposite to the conveyance direction. The extension direction of the nozzle guide is such that the downstream side of the guide is closer to the fold line than the upstream side, and the upstream side is closer to the edge of the fold piece facing the fold line than the downstream side. Since the movement direction of the nozzle mover is opposite to the conveyance direction, the extension direction of the guide is such that the upstream portion in the conveyance direction is closer to the fold line than the downstream portion, and the downstream portion is closer to the edge of the fold piece facing the fold line than the upstream portion.

Although the case has been shown in which adhesive G is discharged from the nozzle 35 when the nozzle mover 83 moves the carriage 831 to the right from the home position, adhesive may be discharged from the nozzle when the carriage is moved to the left and the adhesive may be applied to the sheet, or adhesive may be applied when moving left and right in the width direction. When moving the nozzle 35 to the cleaning position, the nozzle mover 83 moves the carriage 831 to the left from the home position, but when the nozzle 35 is detached and cleaned, it is not necessary to provide a nozzle cleaning position within the device, and the cleaning position may be disposed on the other side of the conveyance path, which is the right side in FIG. 3.

Although the apparatus for processing sheets includes the first creaser 5 and the second creaser 6, the apparatus for processing sheets does not have to be disposed with creasers. By forming fold lines on the sheet at the same time as the sheet is cut into a predetermined shape in advance by a cutting die, the sheet can be folded properly even if the apparatus for processing sheets does not have a creaser.

The rotor 72 includes a rotor that rotates the fold piece P toward the hold piece B around the fold line C formed on the sheet S as the swing center, but instead of this, a point other than the fold line may be used as the swing center to bring the fold piece close to the hold piece, and the fold piece may be moved the required amount parallel to the main body and folded, rather than being rotated.

Furthermore, the folder 7 folds the sheet S at longitudinal creases along the conveyance direction of the conveyor 2 or at transverse creases along the width direction orthogonal to the conveyance direction, but the fold lines may be oblique to the conveyance direction. Furthermore, the retractor 39 includes a mover 30 that moves the pivot support 37 that pivotally supports the nipping roller 281 toward the outside of the conveyance path 20, but the roller itself may be moved, or the roller may be retracted to a position above or below the conveyance path 20 that does not impede the folding operation.

At the retraction position, the pivot 34 is aligned in the vertical direction, but in the retraction position, the pivot of the roller may be retracted to the outside of the conveyance path along the conveyance direction. In addition, the nipping rollers 281 to 288 that can be retracted by the retractor 39 are divided into three in the width direction W, but they may be divided into two, four or more, or may not be divided at all. In addition, the length of the nipping rollers 281 to 288 in the width direction W is about half the length of the width direction W of the conveyance path 20, but it may be shorter than half, longer than that, or longer than the length of the conveyance path.

Although the retractor 39 is disposed on only one side of the conveyance path 20, if the rollers are divided in the width direction and each is individually supported on a shaft, the retractor may be disposed on the left and right sides of the conveyance path, and the nipping rollers may be retreated to both the left and right sides of the conveyance path.

Furthermore, the apparatus for processing sheets 1 includes the first and second applicators 31 and 32, but may include three or more applicators. In the second applicator 32, the sheet S is folded at the fourth folder 14 without being conveyed, with the adhesive G applied to the fifth piece Y at the position, but the adhesive may be applied by the first applicator. If the adhesive applicator and the folder are disposed in separate locations, the sheet may be conveyed after the adhesive is applied until the fold line of the sheet reaches a predetermined folder, and when the fold line reaches the appropriate folder, the transport of the sheet may be stopped and the folding process may be performed.

Although the apparatus for processing sheets 1 includes the first creaser 5 and the second creaser 6 for forming fold lines, when folding a sheet with fold lines already formed therein, the apparatus for processing sheets 1 does not need to include an assembly for forming fold lines. Furthermore, although the apparatus for processing sheets 1 includes the first to fourth folders 11-14, it is sufficient to include at least one folder, and it may include two or three folders, or it may include five or more folders.

Furthermore, the shape of the sheet to be folded by the apparatus for processing sheets 1 is not limited to those shown in the above embodiments, and may be any sheet that can be folded along fold lines, and may be a sheet for forming a storage box for business cards, a sheet for forming a container for storing bottles, containers, and spirits, etc., or a sheet for forming various folding papers such as Christmas cards, membership cards, and coupons.

Although the various processing information is manually set by the user via the operation panel, it may be automatically input by reading a barcode or two-dimensional code with a reader, or may be set by communicating with an external information folder such as a personal computer. Also, a plurality of sheet folding patterns may be stored in advance in a storage means by manual input from the operation panel, and each pattern may be called up by number and set.

Furthermore, the nipping rollers 281 to 288 adjacent to the upstream and downstream sides of the folder 7 that performs folding are retracted by the retractor 39, but all of the nipping rollers 281 to 288 may be moved to the retraction position at once.

The position adjuster 191 includes an operation part such as a hand crank, but the position adjuster may be configured to automatically move the guide. In this case, the controller controls the position adjuster to adjust the position of the guide in the cross direction based on the processing information of the sheet. The guide is automatically moved in the cross direction by the drive of the position adjuster.

Although the sensor mover 904 is disposed to move the sheet sensor 903 in a direction intersecting the conveyance direction F of the conveyor 2, a plurality of sheet sensors may be arranged in parallel in the intersecting direction without providing a sensor mover. The supplier 16 may move the suction pad as is. The folder link assembly 733 may not be disposed, and the sheet may be conveyed as is. The presser 8 may not be disposed.

All the nipping rollers 28 of the first machine 101 and the nipping roller 28 arranged at the most downstream of the second machine 102 are not divided in the width direction W and are composed of one roller, but may be divided into plural rollers in the width direction. Although the case where the nipping rollers 281 to 288 are divided into plural rollers in the width direction W has been shown, they may not be divided, and may be divided into two or four or more rollers instead of being divided into three rollers in the width direction. In addition, in FIG. 1, the nozzle 351 of the first applicator 31 is disposed downstream of the nipping roller 283, but the nozzle may be disposed at the same position in the width direction as the upstream nipping roller. In this case, the nozzle and the nipping roller are arranged side by side in the width direction. The nozzle faces the conveying roller shown on the upstream side in FIG. 1. If the nipping roller impedes the movement of the nozzle in the width direction, the nipping roller is moved to the retraction position. Similarly, the second nozzle 35 of the second applicator 32 is disposed on the upstream side of the nipping roller 285 in the above embodiment, but the second nozzle may be arranged in parallel with the downstream nipping roller in the width direction. If the nipping roller impedes the movement of the second nozzle in the width direction, the nipping roller is moved to the retraction position.

What is claimed is:

1. An apparatus for processing sheets comprising:
a conveyor that conveys a sheet on which a plurality of fold lines are set;
a folder that folds the sheet conveyed by the conveyor along the fold lines;
an applicator that applies an adhesive to the sheet; and
a controller configured to control the conveyor, the folder, and the applicator, wherein
the controller includes:
an acquirer configured to acquire processing information of the sheet;
a fold line determinator configured to determine, based on the processing information acquired by the acquirer, which one of the plurality of fold lines along which the sheet is to be folded by the folder; and
a folding controller configured to control the folder to fold the sheet in accordance with determination of the fold line determinator.

2. The apparatus for processing sheets according to claim 1, comprising:
a loading tray on which the sheets to be folded by the folder are stacked, wherein
the controller includes:
a calculator configured to calculate, based on the processing information acquired by the acquirer, a loading position at which the sheets are to be loaded on the loading tray; and
a loading instructor configured to instruct the user to load the sheets at the loading position calculated by the calculator.

3. The apparatus for processing sheets according to claim 2, comprising:
a guide that guides a side of the sheets loaded on the loading tray, wherein
the loading instructor includes a guide instructor indicating a position of the guide in a direction intersecting a conveyance direction of the conveyor.

4. The apparatus for processing sheets according to claim 2, wherein
the applicator includes:
a nozzle configured to apply an adhesive to the sheet; and
a nozzle mover that moves the nozzle relative to the sheet,
wherein the calculator includes an application calculator configured to determine the loading position within a range in which the nozzle is movable relative to the sheet by the nozzle mover.

5. The apparatus for processing sheets according to claim 1, wherein
the folder includes a plurality of holding members for holding hold pieces of the sheet on the conveyance path, and
the folding controller includes a hold determinator configured to determine which of the plurality of holding members to use.

6. The apparatus for processing sheets according to claim 2, wherein
the folder includes a plurality of holding members for holding hold pieces of the sheet on the conveyance path, and
the folding controller includes a hold determinator configured to determine which of the plurality of holding members to use.

7. The apparatus for processing sheets according to claim 1, comprising:
a sensor that detects the sheet on the conveyance path; and
a sensor mover that moves the sensor in a direction intersecting a conveyance direction of the conveyor, wherein
the controller controls, based on the processing information, the sensor mover to move the sensor to a predetermined position in the direction intersecting the conveyance direction.

8. The apparatus for processing sheets according to claim 2, comprising:
a sensor that detects the sheet on the conveyance path; and
a sensor mover that moves the sensor in a direction intersecting a conveyance direction of the conveyor, wherein
the controller controls, based on the processing information, the sensor mover to move the sensor to a predetermined position in the direction intersecting the conveyance direction.

9. The apparatus for processing sheets according to claim 7, wherein the controller is configured to detect, via the sensor, whether the sheet is loaded at a predetermined loading position.

10. The apparatus for processing sheets according to claim 8, wherein the controller is configured to detect, via the sensor, whether the sheet is loaded at a predetermined loading position.

11. The apparatus for processing sheets according to claim 9, wherein the controller outputs a warning signal when the sheet is not loaded at the predetermined loading position.

12. The apparatus for processing sheets according to claim 10, wherein the controller outputs a warning signal when the sheet is not loaded at the predetermined loading position.
